(19) United States
(12) Patent Application Publication
(10) Pub. No.: US 2005/0208930 A1
(43) Pub. Date: Sep. 22, 2005

(54) Method and apparatus for arranging network content on mobile devices

(76) Inventor: Robert Zmrzli, San Jose, CA (US)

Correspondence Address: SHEMWELL GREGORY & COURTNEY LLP, 4880 STEVENS CREEK BOULEVARD, SUITE 201, SAN JOSE, CA, 95129, US

(21) Appl. No.: 10/888,744

(22) Filed: Jul. 9, 2004

Related U.S. Application Data
(60) Provisional application No. 60/550,928, filed on Mar. 5, 2004.

(51) Int. Cl. H04M 1/00

(52) U.S. Cl. 455/414.4

(57) ABSTRACT

A method for enabling wireless communications is provided. The method includes detecting one or more user actions when the user is browsing one or more network sites. One or more content items may be selected from the page based on the user interaction. The content items may be formatted for a specific end device based on the one or more content items. The content is directed to an end device that has wireless communication capabilities.

### RELATED APPLICATION

This application claims benefit of priority to U.S. Provisional Patent Application No. 60/550,928 (attorney Reference No. ZMRC-P101P), naming Robert Zmrzli inventor, and filed Mar. 5, 2004. The aforementioned priority application is hereby incorporated by reference for all purposes.

### TECHNICAL FIELD

The disclosed embodiments relate generally to the field of network communications. In particular, the disclosed embodiments relate to techniques for providing dynamic network content to target devices.

### BACKGROUND

Mobile devices such as cell phones and personal digital assistants (PDAs) have in their evolution become more functional devices. Among the added functionality, mobile devices are more capable of displaying rich media and performing wireless functions.

Mobile devices have over the years become more functional, particularly in the area of wireless communications. For example, wireless telephony and text messaging are fairly standard features. However, despite the advances in providing enhanced wireless functionality to wireless devices, the usefulness of interconnecting mobile devices to data networks is fairly limited. There are many reasons for this. Wireless data networks tend to be slow or have limited bandwidth. High-speed wireless networks do exist, but they have limited coverage and are expensive. In addition, mobile devices have limited user-interface capabilities, making network browsing a difficult experience.

### BRIEF DESCRIPTION OF FIGURES

FIG. 1 is a block diagram illustrating a method for using a user's browsing activity to define network content that is to be used for content on a target device, according to an embodiment.

FIG. 2 illustrates system for providing network content to one or more target devices, under an embodiment.

FIG. 3 is a block diagram illustrating a basic machine architecture of a system such as described in FIG. 2, according to an embodiment.

FIG. 4 illustrates a software architecture according to an embodiment of the invention.

FIG. 5 illustrates a method to enable a user to create a recipe for selected content items that are to be delivered to a specific end device, according to an embodiment.

FIGS. 6A and 6B illustrate sample user-interfaces for enabling a user to perform a method such as described in FIG. 5.

FIG. 6C illustrates a sample user-interface to enable a user to deploy a recipe that the user created, according to an embodiment.

FIG. 7 illustrates a method for retrieving content items from network sites using recipes, according to an embodiment.

FIG. 8 illustrates a user-interface from which the user may make selections of existing recipes, according to an embodiment.

FIG. 9 illustrates a method for locating content items on network pages independent of updates and position shifts of the content items, according to an embodiment.

FIG. 10 illustrates a technique for reducing bandwidth when sending content messages, under one embodiment

FIG. 11 illustrates processes that are performed under an embodiment in taking selected content items from a designated network site, under an embodiment.

FIG. 12 describes a technique for compressing and/or encrypting data, according to an embodiment.

FIG. 13 illustrates a method by which content may be tagged so that its delivery on an end device results in the end device performing some designated action on that content.

FIG. 14 illustrates a technique for rendering content form an incoming content message, under an embodiment.

FIG. 15 illustrates a method where tagged content may be delivered to a device that is not always active, under an embodiment.

FIG. 16 illustrates an end device configured so that a content message 126, 126 can be rendered on a corresponding window.

FIG. 17 illustrates an application for using speech to send content to a target device, according to an embodiment.

FIG. 18 illustrates a method in which input entered on a target device may be used to affect content delivery to that device, under an embodiment.

In the drawings, the same reference numbers identify identical or substantially similar elements or acts. To easily identify the discussion of any particular element or act, the most significant digit or digits in a reference number refer to the Figure number in which that element is first introduced. Any modifications necessary to the Figures can be readily made by one skilled in the relevant art based on the detailed description provided herein.

### DETAILED DESCRIPTION

General Overview

Embodiments of the invention include methods, systems, and techniques for providing network content to a target device. According to some embodiments described herein, a user is enabled, or otherwise facilitated, in utilizing network browsing actions or activity at a particular network site in order to define what network content from that site is to form the bases of the content delivered to a target device. In particular, the activity may be performed in relation to content that is already rendered from the network site.

In addition, embodiments described herein also enable the user to specify schedules for content delivery, and configure the manner in which the content appears on the target device. One particular useful medium for an embodiment such as described is a wireless medium. Content delivery for wireless mediums may be optimized by segmenting and reducing data that comprise the content being delivered. As such, embodiments enable the use of inexpensive wireless protocols such as short message service (SMS) formatted messages to deliver the content. For example, one embodiment permits SMS messages to deliver network content that was originally richly formatted in a markup language on a web-site.

According to one embodiment, the browsing actions of a user may be observed when content resources provided on the network sites are rendered, or are otherwise in a rendered state, for the user. The browsing actions may correspond to user-actions, such as mouse/pointer clicks, command entry (alphanumeric, voice etc.), menu/icon selection, and navigation between and amongst network sites. Content resources include any programmatic or data structure provided on a network site that is renderable by a browser. The user actions may cause the selection of distinct content items from a larger collection of rendered content resources. The content items may be copied or reproduced, and then delivered to other devices. Data corresponding to content for the target device may be generated based on the content items. For example, text-based data may be generated as content based on a markup-language web page from which the user selects a page segment or area. The data may then be transmitted, or otherwise caused to be sent, to the target device.

As used herein, a target device may correspond to any device having processing resources for being able to receive and process data from a network. Typical examples of target devices include personal and laptop computer systems, or any other type of network terminal. An embodiment such as described may have application to wireless communication systems and devices. In particular, an embodiment may be applied to devices that can communicate and receive data over a cellular network. Examples of such devices include smart cellular phones and personal digital assistants. Other examples of target devices for use with embodiments of the invention include computing stations that are mounted to moving mediums, such as vehicles and airplanes. Such stations may receive communications through satellite communications. For example, an embodiment provides that a user may initiate delivery of content from network sites to a computer that resides in the user's vehicle.

A messaging technique may be implemented in order to transmit data corresponding to content. For example, if the target device corresponds to a smart cellular phone, the data may be transmitted in data blocks as email messages or SMS messages, using an email address of the phone.

Some of the embodiments described herein enable the delivery of network content to mobile devices using wireless communication mediums. According to one embodiment, transmission of data corresponding to a particular content item is detected. A source of that particular content item is identified. A content based at least in part of on the data is displayed, and a position of the content on the display is determined based on the source of that content item.

In one embodiment, the display area may be segmented, and one or more segments may be designated to display content from a corresponding network site. For example, the display area may be segmented into windows, and each window may display content that originated from a different network site.

Still further, an embodiment provides that an operation may be performed on the data before the content is displayed. The operation may affect an appearance of the content. For example, the operation may convert text-based data into a graphical form, such as a chart, graph, or image.

According to other embodiments, a display area of a mobile device may be segmented into areas. Each area may be designated to display content from a corresponding network site. The first content and the second content may be displayed concurrently and refreshed or updated independently of one another. Furthermore, the segments of the display area may be arranged, sized or otherwise configured independently of one another. Each of the first content and the second content may be derived from a transmission of a set of data, where each set of data represents a copy of a particular content item at the particular network site.

According to another embodiment, network content may be provided to mobile devices by performing steps that include copying content items provided at a plurality of network sites, including at a first network site and a second network site. Data corresponding to the copied content items may be generated. As part of the data, a source of the first content item may be identified as the first network site, and a source of the second content item may be identified as the second network site. The data may then be messaged to the mobile device.

With respect to techniques and methods described some or all steps of such methods or techniques may be performed on a mobile device having components that include a processor, communication port, and an output mechanism, such as a display, display area (e.g. projector), or audio output device. For mobile devices in particular, the communication port may include a port to receive wireless communications, such as from a cellular network.

For communications to wireless end devices, embodiments provide that an identification is made of a device's representation of a content provided at a network site. When the content at the network site is changed, data that corresponds to the change is identified. The representation of the content on the target device is also changed. The result is that the representation of the content on the end device is altered, and this alteration is primarily based on the change in the content provided by the network site. By “primarily based”, what is meant is based on at least a majority (e.g. 51% correspondence), or substantially based (e.g. 90% correspondence). Thus, a majority of what is altered in the representation of the content corresponds to the change in the content provided by the network site.

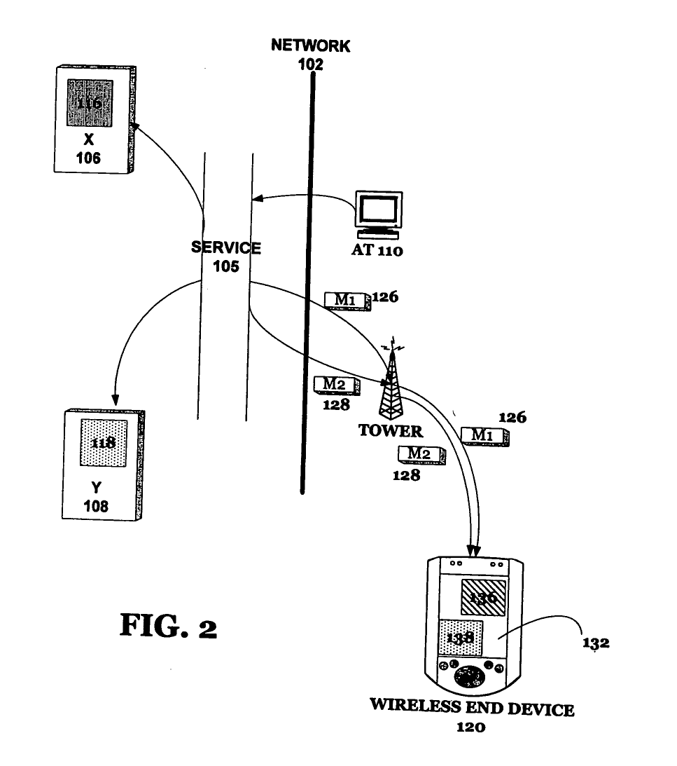

An embodiment such as described may be performed by a service (e.g. service 205 in FIG. 2). The identification of the device's representation may correspond to identifying what data was previously transmitted to the target device. In one embodiment, identifying the change in the content item may be performed by maintaining a history of the content item, so that the change in the content at a particular instance may readily be determined using comparison measurements or operations. For example, the history can be maintained on a server or service, and referenced before a comparison between the content at a particular instant and the last instance is made. Still further, a mobile device may be configured to perform the operations of identifying the change in the content item.

But if the change in the content item is determined for purpose of determining what data to send to the mobile device, the amount of data that needs to be sent is less. For narrow bandwidth channels, such as wireless mediums, this is beneficial. In one embodiment, data representing the change in the content item may be segmented in pieces, and each segment may be transmitted over a narrow channel. For example, in a wireless medium, a series of SMS messages may be sent to smart phones or other devices.

One or more embodiments described herein may be implemented using modules. A module may include a program, a subroutine, a portion of a program, a software component or a hardware component capable of performing a stated task or function. As used herein, a module can exist on a hardware component such as a server independently of other modules, or a module can exist with other modules on the same server or client terminal, or within the same program.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holing data and instructions. Examples of computer-readable mediums include permanent memory storage devices, such as hard drives on personal computers or servers. Other examples of computer storage mediums include portable storage units, such as CD or DVD units, flash memory (such as carried on many cell phones and PDAs), and magnetic memory.

Functional Overview

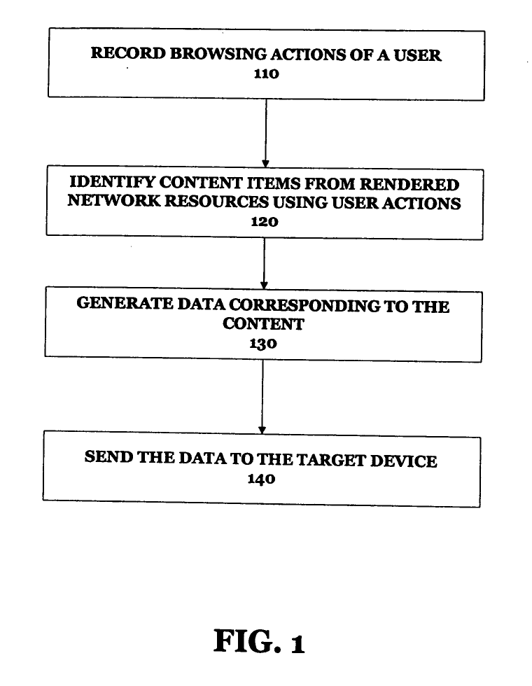

FIG. 1 illustrates a method for enabling content delivery to one or more target devices. A method such as described may be used to enable a user to deliver content to any type of network-enabled device. This may include terminals that are connected to the Internet or enterprise specific Intranet, and wireless devices.

In step 110, the actions of a user are recorded in relation to a user's experience of having resources from a particular network rendered. The duration in which the user actions are recorded may be designated. For example, the user may initiate when the recording is to start and stop. In one embodiment, the interactions of a user with software (e.g. a browser or browser interface) or with a terminal are recorded when the network resources are in a rendered state on the user's terminal. For example, any input the user provides in order to browse a particular network site (and sites internal to that network site) may be recorded. Examples of the inputs may include pointer (such as a mouse or touchpad) movement, a pointer selection or click, a string of one or more keyboard selections or other button presses, and a click and drag motion of a pointer (such as to highlight text or image on a web page). Examples of the inputs may also include operation of user-interface features, such as icon or hyper-link selection, menu selection, alphanumeric entry, and voice command (that is received and understood by software). In a typical scenario, the user's actions are recorded on a terminal with broadband access to the network sites of interest, such as a user's personal computer, because content delivery is desired for devices that more limited or expensive access to the same network sites.

In an embodiment described elsewhere in this application, the actions of the user are recorded by providing the user an interface with a browser that can render network content, such as markup language formatted network pages. The interface may be combined with the browser on a client terminal. For example, the user may download an application that is automatically executed on the client terminal with the user's browser. When executed, the application serves as a recording interface for the user's browsing activity. Alternatively, another embodiment provides that the interface is a network application, that runs in conjunction with a network site. For example, a website may include an interface layer that records the user's activities at that website. In either case, user's browsing actions are recorded. The actions may be recorded when network resources are in a rendered state. Examples of rendered network resources include text, image, audio/video files, computational module (loan calculator), lookup database (e.g. zip code finder) and other media.

Step 120 provides that the user's actions are used to identify one or more content items from the rendered network resources. For text-based content, these content items may correspond to specific articles, paragraphs, page sections (e.g. the front page of an online newspaper), bulletins. Images, media files or other specific content items may be selected for target devices that can handle content based on such resources. As another more complicated example, the content items may correspond to the text output of a computational module provided at a network site. This example may correspond to weather information that is provided at a weather site that requires the user to enter his or her location. In this example, the recording may reflect number strings that the user enters to specify his own zip code, as well as icon selection by the user to initiate the lookup of weather based on zip code.

In step 130, data corresponding to content is generated, where the content is based on the identified content items. This may involve stripping the content items of links, images, advertisement or other unwanted content in order to focus on the particular content item that is of interest to the user. For example, the user's device may not be capable of efficiently carrying any content other than text content, in which case the data generated in this step is only the text portion of the content item. In one embodiment, the data is also generated for transmission across a specific type of medium, such as a cellular or other narrow-bandwidth network. The data generation may be formatted for transmission across the identified medium. For example, for cases where the target device communicates on a cellular network, the data may be generated in segments that can form individual SMS formatted messages.

Step 140 provides that data is sent or otherwise caused to be sent to the target device. As mentioned, the target device may correspond to any type of network enabled device, including personal computers that are connected to the Internet using a normal land connection. However, embodiments described herein have particular application to cases where target devices have limited (or at least more limited) and more expensice access to data networks. In particular, wireless networks, including cellular networks such as GSM (Global System for Mobile Communication), CDMA (Code Division Multiple Access), and TDMA (Time Division Multiple Access) networks provided by wireless carries such as VERIZON, CINGULAR, and AT&T WIRELESS, can be expensive and slow. According to an embodiment, the data may be transmitted in the form of a message (or a series of messages), such as an e-mail address associated with the target device.

According to an embodiment, the data may also be formatted to accommodate one or more attributes of the target device. For example, for an application in which the target device is wireless, the data may be formatted by segmenting the data into SMS message segments. Other attributes to consider in formatting the data include the manufacturer, model type, display size, pixel resolution and bandwidth available to the target device.

System Overview

FIG. 2 illustrates system for providing network content to one or more target devices, under an embodiment. For an embodiment such as shown in FIG. 2, a system includes an access terminal 110, a network 102, and a wireless end device 120 as the target device. A service 105 may be provided over the network 102. In one implementation, the access terminal 110 corresponds to a personal computer, such as a desktop or laptop computer. The network 102 may correspond to the Internet. Alternatively, the network 102 may correspond to an Intranet or other wide-area or local area networks. The wireless end device 120 may include a PDA, a cellular phone device, or any other portable computing device with wireless communication capabilities. For example, the wireless end device 120 may include a laptop computer equipped with a wireless network card. Another typical application for an embodiment includes a wireless end device that can carry both voice and data.

In practice, a user communicates with service 105 through access terminal 110 in order to specify network sites 106, 108 from which the user wishes to retrieve content for specified end devices 120. As will be described, service 105 presents an interface to those sites, on which the user makes selections for specific content items 116, 118 that appear on those sites. The user may make the specification using access terminal 110. The service 105 records specific content items 116, 118 selected by the user from the sites 106, 108. The service 105 may then deliver, or cause to be delivered, formatted content messages 126, 128 that are based on content items 116, 118.

In an embodiment, end device 120 uses the content messages 126, 128 to generate multiple presentations 136, 138. Each presentation may be provided in a window or other segment of a display area 132 of the wireless end device 120. The presentations 136, 138 may display content updated from respective sites 106, 108 concurrently or simultaneous with one another. In the case where the content items 116, 118 are dynamic, the presentations 136, 138 may in turn provide updated content in near real-time. In one embodiment, presentations 136, 138 appear together at one time on the same display 132 and correspond to the most recently retrieved content form each site 106, 108.

Embodiments described herein enable the user to specify what content items on a particular page of network site 106, 108 are to be retrieved. In addition, the user is able to specify a schedule, including frequency, for retrieving those content items. Various other configurations are also possible. For example, the user may specify the type of device, screen size, color/monochrome, screen resolution, pixel size and font size in order for service 105 to configure the format of the content messages 126, 128.

Service 105 may send, or cause to be sent, the content messages 126, 128 using any wireless messaging medium. For example, one embodiment provides that content messages 126, 128 are transmitted from service 105 using a short message service (SMS). The advantages of using SMS is that for many data wireless services, SMS is free, or at least relatively low cost. Use of SMS messaging is also abundantly available over the globe.

Various other embodiments, implementations, details and advantages will be made more clear with the descriptions provided below.

Machine Architecture

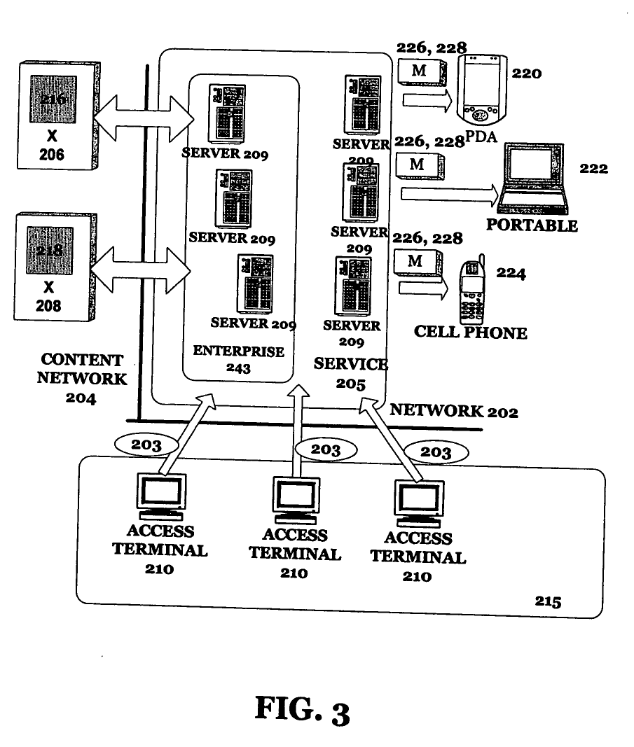

FIG. 3 is a block diagram illustrating a basic machine architecture of a system such as described in FIG. 2, according to an embodiment. The machine architecture illustrates how servers, computers, and clients may communicate with one another over a network.

FIG. 3 illustrates a system in which a plurality of access terminals 210 are communicatable with a service 205 over a network 202. Each of the access terminals 210 may be used to specify content that is to be delivered to a corresponding end device using the service 205. The service 205 has access to content network 204, which may be the same as, or different from, network 202. In one embodiment, service 205 may include a cluster of servers 209. A system such as described contemplates a plurality of wireless end devices, of which each is configured to receive and render content provided from content network 204. For purpose of illustration, end devices include PDA 220, laptop computer 222, and cell phone 224. Some of the end devices may include specialized software for enhanced display features, such as multiple window display of content from multiple sites (see FIG. 2).

In one embodiment, each access terminal 210 may include one or more client applications, that when executed, provide the user with functionality for one or more of the following: (i) communicate with service 205, and (ii) provide an interface for enabling a user to communicate with service 205. As described below, the client application on the access terminals 210 may be specialized for service 205. Alternatively, some or all of the access terminals 210 may have no specialized software, but interact with service 205 through a generic browser or other communication application. Alternatively, the service 205 may provide its own browser component for the access terminal 210. Still further, as described in more detail below and with other embodiments, each access terminal 210 may also include a component that enables that access terminal 210 to be part of the service 205, either for itself or for other access terminals. Accordingly, the cluster of access terminals 210 may act together to provide a supplemental service 215. The supplemental service 215 may perform some or all of the functions that service 205 performs, including retrieving and sending content from network sites to end devices. In fact, while service 205 is shown to be comprised of servers 206, embodiments contemplated herein may provide for the service 205 to be entirely in the form of a distributed architecture, so as to only include access terminals having both client and server roles.

By communicating with service 205, a user operating one of the access terminals 210 may provide specification information 203 for specifying, among other things, one or more of the following: (i) one or more wireless end devices; (ii) sites (e.g. pages that can be rendered with uniform resource locators (URLs)) on content network 204 from which content is to be acquired; (iii) portions of the pages appearing at the selected sites that are of interest; (iv) a schedule for checking the selected sites and/or delivering content based on those sites to one or more specified end devices. The service 205 may use the specification information 203 to access selected sites 206, 208, copy selected portions of those sites 216, 218, and format content messages 226, 228 to one or more specified end devices 220-224. The specified end device(s) 220-224 may execute client applications that enable those devices to render the content messages 226, 228.

The end devices may be configured to render content messages 226, 228 simultaneously or concurrently with one another. The content messages 226, 228 may be rendered in separate windows or display screen portions. To this end, each end device 220-224 may include an application for rendering the content, including assigning the content messages to windows or portions of the display screen. In another embodiment, end devices may be equipped to include some or all of the client application on the access terminal 210. However, depending on the type of device, the ability to place any part of the client application on the end device may be limited because of insufficient processing and memory resources, input/output interfaces (e.g. no keyboards or small screens), and limited communication bandwidth. For this purpose, the application on the end device may be a “thin client”. Furthermore, physical characteristics of the end devices may limit the functionality and features available for displaying content items 226, 228. For example, the display size of cell phone 224 may limit display of more than one content item on that device.

According to an embodiment, the specification information 203 specifies a separate schedule for updating content on each window. The specification information 203 may be altered or updated by the user, either through the access terminal 210 or through operation of the end device.

According to an embodiment, service 205 may include one or more servers 209 that are configured to access and retrieve content from network sites on the content network 204. In such an embodiment, the servers 209 may be a separate class of machines from access terminals 210, which are user operated. In one variation, some or all of the servers 209 in the service 205 are part of an enterprise system 243. The enterprise system 243 may include an Intranet or other local area network as part of content network 204.

In another embodiment, service 205 is comprised of access terminals 210, or a mix of access terminals and servers 203. Such an embodiment may correspond to a distributed architecture module, where each access terminal 210 has dual client-server roles. Each access terminal 210 may execute a client and server application. The server application of each access terminal 210 enables content retrieval and delivery to end devices. According to one embodiment, each access terminal 210 may service multiple end devices. The user of access terminal 210 may have little or no control over what end devices are serviced by that computer. One server may exist to coordinate the resources of the different computers.

Software Architecture

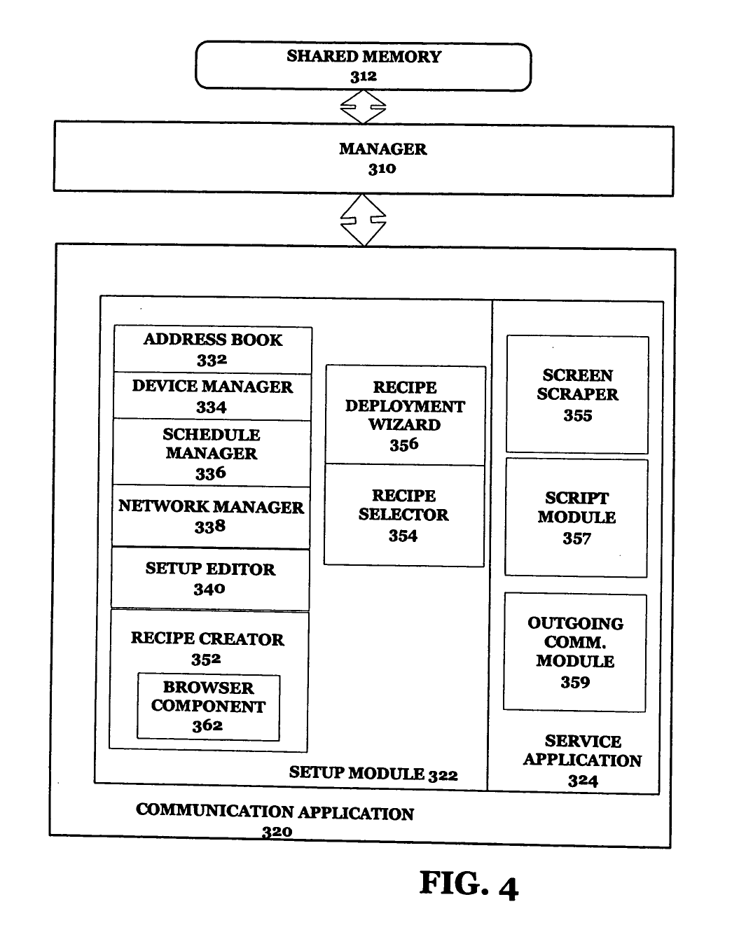

FIG. 4 illustrates a software architecture according to an embodiment of the invention. An architecture such as described may be implemented for use with, for example, access terminal 210 in a system such as shown by FIG. 3. An embodiment such as described in FIG. 4 assumes that at least part of service 205 is provided under a distributed architecture model. Thus, access terminal 210 may have dual client-server roles.

According to one embodiment, components of access terminal 210 include a communication application 320. The access terminal 210 may communicate through communication application 320 to a manager 310 on the service 205. The manager 310 accepts connections from other terminals, makes available a shared memory 312, and coordinates resources of different access terminals 210 that form part of the service 205. Among other operations, manager 310 may perform a load-balancing operation to ensure that resources of the system are managed efficiently. For example, in an embodiment where the access terminals 210 form part of, or are the service 215, manager 310 ensures that no terminal has a disproportionate load. In addition, when one terminal goes down, the manager shifts the loads to other terminals.

The shared memory 312 stores, among other things, user preferences, profiles, and a public library of recipes. The shared memory 312 may store the preferences and profiles for all users that use the services. In addition, the shared memory 312 may store a public library of recipes. Each recipe in the library includes data and/or instructions for locating and scraping desired content data from a selected network site. To this end, each recipe may include (if necessary) specific instructions on how to access a network site where desired content items are provided, user data that is required for desired content items to be made available (e.g. text entry), and segments of the pages for those sites that the user has indicated are of interest.

The communication application 320 may include a setup module 322 and a service application 324. The service application 324 executes recipes for identifying network content and sending the content to the end device, based on configuration information provides by the user. The setup module 322 is executable to interface and prompt the user for the configuration information.

According to one implementation, the setup module 322 includes an address book 332, a device manager 334, a schedule manager 336, a network manager 338, and a setup editor 340. The setup module 322 provides an interface for each of these components. The address book 332 provides an interface on which the user may enter the address of the wireless end device(s) (see 220-224, FIG. 3). Since one user may use multiple wireless end devices with service 205, the address book 332 may accept multiple addresses. The address book 332 may provide fields or other prompts for the user to enter a messaging identifier for a desired device. In a typical case, messaging identifier may include the devices phone number (if it is a phone) or wireless messaging address, which may be in the form of <phone number@wireless-service>, where “wireless service” refers to the devices wireless carrier. Examples for the wireless carrier include VERIZON, CINGULAR, and SPRINT.

The device manager 334 provides an interface by which the user can provide information about the device that is to receive the content. This information may include the device type (smart phone, dumb cell phone, wireless PDA etc.), device model, display size, pixel size, font size and/or individual character sizes or widths. The schedule manager 336 enables the user to enter scheduling information on when content is to be delivered to each of the devices specified in the setup. The scheduling information may include what period and frequency for which content delivery is to take place. An example includes a setting of the days in a week for which content is retrieved from a particular network site, and the frequency on which the content is retrieved on different days or time periods or calendar dates. Network manager 328 may provide an interface to enable the user to specify the connectivity of the terminal 210 with the network in use (e.g. the Internet). In one implementation, schedule manager 336 provides preconfigured schedules. These schedules may be identified by name. For example, a schedule that instructs service 205 to check a site at 6:30 AM EST and 4:00 PM EST five days a week, not including weekend and holidays, may be called “stock checker”.

The setup editor 340 provides an interface that informs the user of the recipes in use. One implementation also provides that the setup editor 340 shows what devices are to receive each recipe in use (originally specified with the address book 332), and when network sites specified by those recipes are to be checked (originally specified by the scheduler 336). The setup editor 340 may also show recipes that the user has selected or created, and which are in use. Recipe creator 352 provides for the creation of recipes, and recipe selector 354 enables the user to select a recipe from the library in the shared memory 312. When the user creates a recipe, a recipe deployment wizard 356 may enable the user to deploy the recipe onto the public library for public consumption.

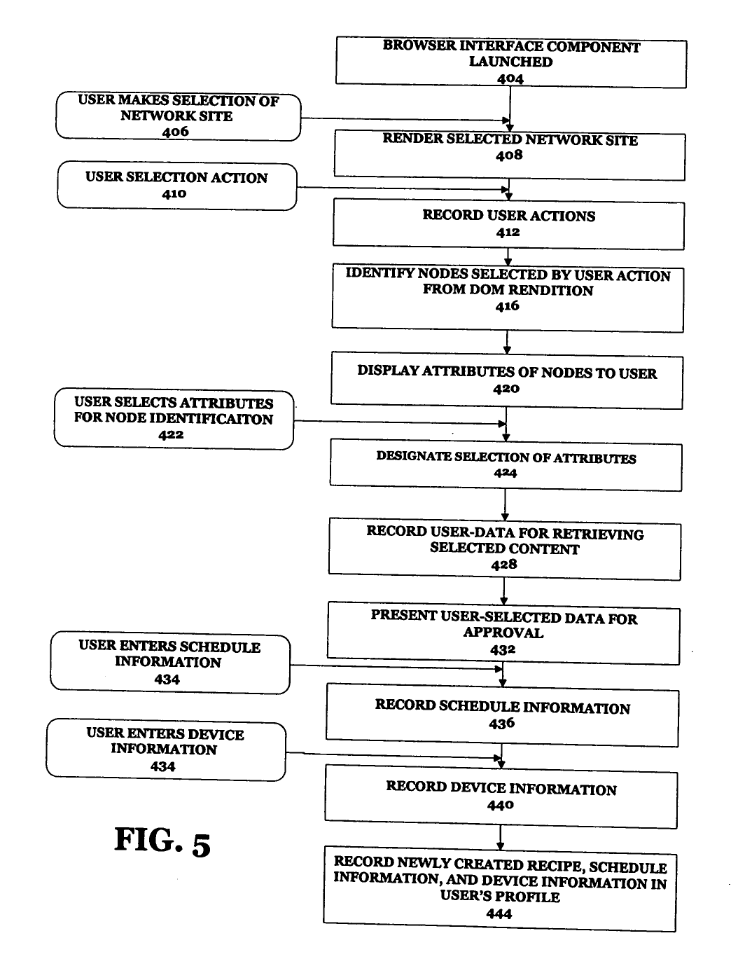

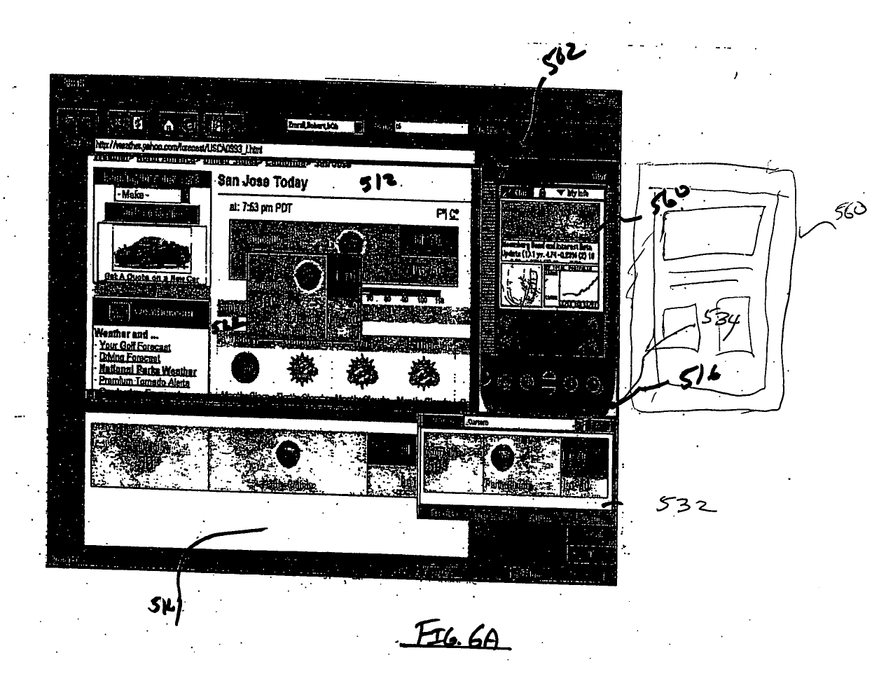

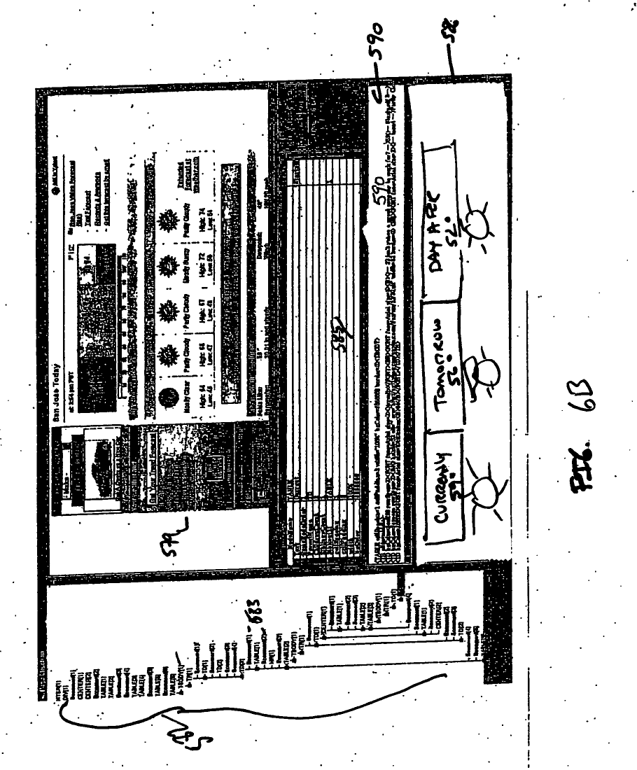

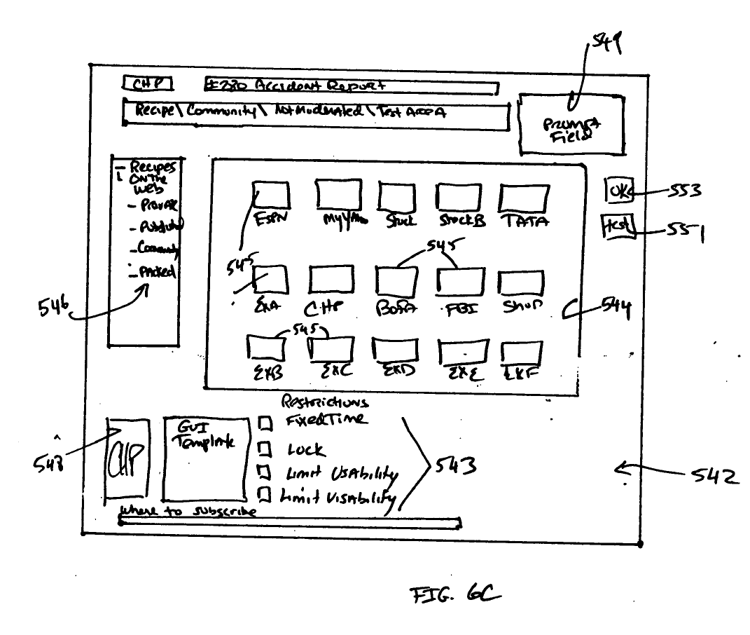

In one embodiment, setup module 322 also includes the recipe creator 352 and a scraper 355. The recipe creator 352 may be executed when the user wishes to create a recipe that is not available in the public library. In an embodiment, recipe creator 352 includes a browser component 362 that maintains a selected network page in a document object model (DOM) rendition concurrently while rendering or otherwise making the network page viewable. For example, the browser component 362 may render network resources, so that while the network resources are in a rendered state, the actions of the user are recorded in making the recipe. In one embodiment, the browser component 362 includes an interface that is capable of associating a user's actions with one or more nodes of the DOM rendition of the page. Certain user actions may be recorded and associated with one or more nodes that are deemed selected. Examples of such user actions include link or icon selection, text entry, point and click/drag, page highlight, and voice commands. The one or more nodes correspond to selected portions of network pages that are to be converted into content messages for the terminal 210 specified in the device manager 334. The selected nodes, along with the address of the network page, are saved in the newly created recipe. Amore detailed discussion of recipe creation is provided in FIGS. 5 and 6A-6B.

The recipe selector 354 provides an interface to enable the user to select a recipe from a library of recipes. The library may be stored in the shared memory 312. When a recipe is selected, the setup editor 340 may prompt the user for information needed to execute the recipe. For example, the user may select a recipe corresponding to a specified weather website. The setup editor may prompt the user 340 for a zip code, so that the correct weather information may be retrieved from that website.

The service application 324 may run in the background of the terminal 210. In one embodiment, service application 324 has no interface. A scraper 355 is one component of the service application 324. The scraper 355 may execute recipes for purpose of retrieving selected content. The selected content may correspond to content associated with nodes that are deemed selected by the interface through the user's actions. Functions of scraper 355 include locating node(s) specified in recipe on a network site. Another component of service application 324 termed the script module 357 may actually locate the network sites using instructions extracted from the corresponding recipe. The service application 324 may also include an outgoing communication module 359 that performs the following actions: (i) parse and retrieve text-based content corresponding to selected nodes; (ii) convert content to message format for terminal 210 using information entered with device manager 334; (iii) create content message identification using address book 332; and (iv) transmit content message to end device. The content message may be sent as a wireless messaging email, similar to sending any email from a computer over the Internet to a cellular phone.

Service application 324 may serve either the terminal 210 on which it resides, or other access computers. Accordingly, information recorded through the setup module 322 may be stored on the shared memory 312. In retrieving content for various users, the scraper 355 of each terminal 210 may access the shared memory for setup information associated with a particular user.

While an embodiment such as described with FIG. 4 illustrates numerous elements of the architecture residing with a client terminal, other embodiments may provide one or more of the elements in the architecture described with FIG. 4 as residing on a network, and available to a terminal. Still further, one or more of the elements may be shared, in that the component resides in part on both the client and the server. For example, elements of the service application 324 may be available to the client over the network, either entirely or as an integrated client-server application.

In another embodiment, recipe creator 352 may run as part of resources made available on a particular network site, or network domain. For specific or select users (such as identified through the use of cookies), recipe creator 352 records those user's browsing activities, or select activities, for purpose of creating recipes for that user. Thus, a website, such as a brokerage site or Internet retail site, may offer users the option of recipe creation, in which case the user can actuate a recipe creator interface that runs at least partially from the website in order to record specific browsing activities of the user. In one implementation, the recorded browsing activities correspond to natural browsing activities (enter login and password, click icons, open resources etc.) of the user performed on that website, or on resources rendered from that network site. In another implementation, an electronic form or graphic-user interface may be provided at the website where the user activities are recorded. The electronic form may be used to enter text strings, select options etc. In either case, the browsing activities of the user are recorded from the web site, rather than from an interface running on the user's terminal.

Content Selection

Embodiments of the invention enable a user to make very specific selection of what content is to be delivered to the wireless end device. For example, the user may select specific objects or text items on a web-page. Alternatively, the user may select objects in a user-created window that has dimensions well within the web page defined boundaries. Furthermore, embodiments enable the user to select specific content items from almost any site offering content in the form of a markup language or pure text.

According to an embodiment, users can select what content to retrieve from designated sites through the use of recipes. A recipe may include a set of data and/or instructions that identify a designated set of content items, possibly from a larger collection of rendered content resources (such as a web page with multiple articles or images). A recipe enables those content items to subsequently be located and/or identified on a network site. The subsequent identification of content items may be achieved programmatically. Recipes may be provided with rich media and/or graphics in order to communicate with the user the purpose of that recipe. A recipe may also provide a user with an interface to enable the user to reconfigure the recipe, specify alternative or additional content items, or to specify new instructions.

The user may either select individual recipes from a library (which may be stored in shared memory 312 of FIG. 4) or create their own recipe for a desired site. If, for example, the user wants generic information, such as a stock quote, the user may access the library of recipes and select from multiple stock quote recipes. Each of those existing recipes may be for a particular network site, so if the user wishes to receive stock quotes from a different site, the user may need to create his own recipe. Also, a user may want to enable the service for a site where a recipe does in fact exist, but the user may want a content item that is not addressed by the recipe in the library. For example, the user may wish to access a weather page having a recipe for retrieving five day forecasts, but the user may wish to retrieve information appearing in a barometer field only. Therefore, the recipe for the five day forecast may not be what the user wants, either because it contains unnecessary information, or because it does not cover the content item that is of interest to the user. When the content item of interest to the user does not have a recipe, embodiments of the invention enable the user to create his own recipe to retrieve the content of interest.

According to an embodiment, a user may create a recipe through natural browsing activity. A user may initiate a programmatic recording where during an interval of time, all or select browsing actions of the user are recorded in the context of pages rendered from a network site. In one embodiment, the user may initiate a recording when a page from a web site is rendered, then select specific regions of the web site that the user wants to be the basis of future content delivery. Examples of browsing activity may include the user (i) clicking and dragging to highlight a portion of the web page, (ii) selecting links to internal portions of the web page, (iii) providing a password and login to open a secure page, and/or (iv) inputting alphanumeric text into computational fields (zip code into weather report or street location for traffic report). The sequence of recording events may be simple (e.g. entry of zip code into web field and highlight of result by user), or more sophisticated, requiring a series sequentially relevant user-actions.

Once the recipe is recorded, a server (such as provided by service 205) or other computer may use the recipe to subsequently identify the user's desired content items. The desired content items may be identified independent of the content item's position on a page where the content item was originally selected in making the recipe. Such an embodiment accounts for the normal case where content on a web-site shifts, with the placement of advertisements for example, or images of different sizes. The content items, or portions thereof, may be copied for delivery to target devices specified by the user.

FIGS. 5, 6A and 6B illustrates more detailed techniques in which a user may create a recipe for selected content items that are to be delivered to a specific wireless end device, according to embodiments of the invention. A method such as described in FIG. 5 may be performed by communication application 320, and in particular, recipe creator 352 through use of browser component 362. Additionally, a method such as described may be performed when no recipe exists to the user. For example, the user may view the library of recipes in shared memory 312 and determine specific network content that is not provided for but is desired retrieval to his end device. In order to create a recipe, step 404 provides that browser component 362 is launched.

Recipes may be used to enable programmatic identification of content items of interest at designated network sites. Each recipe may store a script containing data for identifying a designated network site, and for identifying content items of interest on that site. The recipes may also include instructions for making the identifications, if necessary. A component such as scraper 352 may use a recipe to scrape content items of interest from a page on a network site, based on user-selection information.

Step 406 provides that the user specifies the network page of his interest. This network page is where the user wishes to find the content items of interest. Depending on the use, specification the network page may be relatively simple when the desired content items are readily available on a network page. For example, for read-only data that appears on a home page of a particular content item, the specification of the network page is as simple as specifying the home page. However, the step of specifying network sites where content items of interest are located may also be more complex. For example, if the user wishes to access his bank account to view his checking account information, the user may not be able to see the page of interest until first visiting the home site for the bank, locating the field for logging in, entering the login data (such as bank account number) and selecting the checking account information. In this latter example, step 406 may correspond to locating the home page for the recipe. But the actions that need to be performed in order to arrive at the desired page (e.g. the page where the checking account id displayed) may become part of the recipe, requiring additional steps of the method. When this is the case, step 406 may be performed by specifying the network site that is to be the starting point for the recipe.

Step 408 provides that the network site specified in step 406 is rendered for the user through a browser component 362 (FIG. 4). The browser component 362 may provide an interface layer that copies the contents from the network site and renders the contents for the user. The layer of the interface is equipped to record certain actions from the user. These actions are recorded in the recipe so that the scraper 355 can subsequently perform them, automatically. In one embodiment, the browser component 362 renders the network site on the access terminal 210 in its original rich format, while maintaining the network page in the form of a DOM rendition. The DOM rendition of the page identifies content items as nodes, where each node may correspond to one or more of a set of cells, rows, and tables.

Step 410 provides that user selection actions that are for creating the recipe are entered. In a simple case where the recipe is to view data requiring no user interaction (view lottery results), the user-action of this step may correspond to mouse clicks or other input activity by the user for purpose of designated a region on the page of the site specified in step 408. The user activity may correspond to the user physically locating a mouse pointer or making some other indication of where the content item of interest resides. In a slightly more complex case where the user needs to enter data into a field to view the content items of interest, the user-actions may record the user entering the data on the network site where the field is provided. For example, a finance page may be selected as the specified network site in step 406, and the user actions recorded for the recipe include the selection of the ticker symbol entry box, followed by entry of the user's desired ticker symbol (e.g. “IBM”). In the more complex case of the user wanting to view his checking account, the home page of the user's bank may be selected as the specified network site. User-actions that are recorded for a recipe to access content items corresponding to the user's checking account information include the following: (i) user-entry of his login information (including possibly bank account information and password), and (ii) selection of one or more internal pages yielding the account information of checking account. When the checking account information is presented, the user may select the portion of the page where the account information is provided. What is achieved through performance of steps such as described above is a user-friendly mechanism for creating a recipe. According to an embodiment, the recipe can be created by the user performing actions that he normally would anyway when accessing the content items of interest through a desktop computer.

As mentioned, there are many actions that are possible in order for the user to designate the portion of the page where desired content appears. In one embodiment, the actions correspond to mouse-clicks, are similar actions. A drag action may also be included, where a user moves selected content into a selection bin (see FIG. 6A). In step 412, these user actions are recorded. The actions may identify a space of segment on the network page that is to be recorded.

In step 416, nodes in the DOM rendition of the network page that are within the area of the user's selection are identified. Step 420 provides that attributes of these nodes are displayed to the user in a selectable manner. The attributes correspond to information about the nodes that are inherently provided in the DOM rendition of the network page. The attributes may be provided to the user through the browser component 362. Examples of what data may be included in the attributes include node size, number of internal branches within the node, and number of rows in the node. Various other attributes may also be provided.

Attributes for enabling the scraper 355 to repeatedly locate the content items of interest are designated. As described elsewhere in this application, content items tend to shift with time on web pages. The selection of attributes to identify nodes corresponding to content items of interest provides a means for locating and identifying the content items even when those content items shift. In one embodiment, the recipe creator 352 may automatically designate certain attributes of the node as its identifier, such as the node size and the starting characters of the node.

In another embodiment, a user may select attributes based on a determination of what attributes best identify the selected nodes from other nodes on the page. Step 422 illustrates such an embodiment. This decision may be based on the user's knowledge, experience, or even suggested by the service.

Step 424 provides that the designation of attributes are recorded by the recipe creator 352. These attributes are recorded as the identifiers of the selected node(s).

In step 432, the data selected by the user is presented for approval. For example, the user's recordation action may correspond to clicking and dragging content items corresponding to nodes onto a bin in the graphic interface provided by the browser. Other examples of user-actions include entry of login and password information, and entry of alphanumeric input that yields a computational and/or lookup result (e.g. zip code for weather, search term for search engine) Once the user enters the necessary or desired information, a representation of what the retrieved data would look like at the particular time of selection, based on the user-entered data, is displayed to the user. For example, an image of a PDA (which may be based on what the device type specified by the user) may indicate the selected content on its display.

Step 434 provides that user schedule information is received. Step 436 provides that the schedule information is recorded for the selected content item. The schedule information may specify when the selected content items are to be retrieved. In one embodiment, the user is able to set a frequency in different time periods for when the data is to be retrieved. For example, on a site for retrieving stock quotes, the user may specify that the content item corresponding to stock price is retrieved on a wireless end device every 15 minutes from 9:00 AM-4:00 PM EST, 5 days a week, excluding holidays and weekends. At all other times, the user may specify no retrieval. For a weather page, the user may specify retrieval of a 5 day forecast every morning, at a particular time.

Step 438 provides that the user specifies the device, or alternatively is presented with the opportunity to change the device settings. For example, the user may specify the address of additional wireless end devices other than what is recorded in the address book 432 and the device manager 434. Step 440 provides that the user's designation of the wireless end device is recorded. Alternatively, a creator of the recipe can enter schedule information to limit a user's flexibility on adjusting the schedule. The creator may also limit access to the schedule by locking it.

In step 444, the created recipe, schedule information, and device designation are recorded for the user in the user's profile. Subsequently, the service 205 uses the recipe to retrieve the content items for the designated wireless end device according to the specified schedule.

One embodiment provides that once the user creates a recipe, the user has the option to add the recipe to the public library of the shared memory 312 (see FIG. 4). This would make the recipe available to other users. A user may also charge money or other consideration for use of the recipe, and limit the privileges, availability or number of usages in a recipe. Alternatively, the user can store the recipe privately, on for example, in a portion of the local computer that is not accessible to the other users.

FIG. 6A is a sample screen shot of browser component 362 rendering a web page through an interface that can record certain user actions for selecting content on that page. Browser component 362 may capture and render the network page through a graphic user-interface (GUI) 502. The GUI 502 may resemble a traditional browser, with some added features. The displayed data is segmented. A first segment 512 of the displayed data renders the network page with little variation from its original appearance. A second segment 514 corresponds to a drop bin. A user can click and drag selected content items into the bin second segment 514 as a way of performing an act on the GUI that corresponds to selection of a content item for wireless delivery to an end device. A third segment 516 of the displayed data provides a representation of the user's wireless end device. As will be described in greater detail, one embodiment provides the third segment 516 as a mechanism for providing tags to selected content items. The tags identify what action the end device should perform with respect to a particular content item. In embodiment such as shown in FIG. 6A, the action includes determining a screen segment or window on which the content data is to be displayed, concurrently with other content items on other windows.

In an embodiment, a user may select content item 522 on the network page by clicking and dragging the selected content items into the bin of the second segment 514. In FIG. 6A, selected content item 522 is shown in multiple states. In the first segment 512, the state is one where the user is in the act of selecting that content item. The second segment 514 shows the content item after selection. The third segment 516 includes a representation of the end device with how the content item would appear on the display of that device. The representation of the third segment 516 may go so far as showing the window 526 in which the user has selected the content item to appear.

In the example provided, the user has located the specific page of interest corresponding to weather for the city of San Jose, Calif. The recording of the recipe may have been initiated from the previous home page, where a prompt for a specific zip code or region is provided. Once the recording was started, the user may have performed the following actions: (i) enter zip code, (ii) click icon on web page to actuate resource of network site to provide result, and (iii) click page region on search result where desired weather information appears. Alternatively, the network site may maintain the weather page for a designated zip code on a separate URL, in which case the recipe may only be include data corresponding to the user clicking the regions on the page where the content items of interest are located. The user's clicks may correlate to cells in the node corresponding to temperature information and weather condition. Once the user has selected the content items 522, the user may drag the content items into the bin of the second segment 514. This step may signify the end of the recording for the recipe.

The process of recipe creation may account for an identification mechanism for locating content items on the network page independently of position information. This may be beneficial because content appearing on web pages may shift from time to time. For example, content may shift to account for the presence of banner ads that change in shape or position, added graphics that alter a page, or otherwise base don editorial selections. Since recipes enable user's to specify content items for subsequent and repeated retrieval, there is benefit in providing identification information to recipes in order to facilitate the recipes being able to locate content items in the future. In an embodiment, this information may correspond to the attributes of the selected content items 522. The attributes of the selected content items may be determined using an internal DOM rendition of the same network page. The browser component 362 may maintain the DOM rendition of any page, and correlate the user's selection of a particular content item with a node of the DOM rendition. In the DOM rendition, nodes are associated with attributes. Certain attributes may be good identifiers for the node in the DOM rendition. In an embodiment such as shown in FIG. 6A, identifying attributes of a node corresponding to a selected content item are selected automatically and stored with the recipe, so that the user's involvement with creating the recipe remains simple and unsophisticated.

Once the selected content items are placed in the bin of the second segment 516, a panel interface 532 is displayed that enables the user to enter a variety of configuration information affecting how the user wishes for the content item to appear or be used. In particular, the panel interface 532 may provide a refresh field 534 that enables the user to set the frequency, period and other schedule information for how often the scraper 355 is to retrieve the selected content items 522 form the network site.

The representation of the wireless end device may be based on information contained in the device manager 334, as well as other components such as setup editor 340. A window 560 illustrates to the user how the selected content item 522 will appear. In particular, the user may select the window 560, including its position, shape and/or size. By making these choices, the user may, under one embodiment, tag the data for a display segment on the end device. As shown, one embodiment provides that are graphics are stripped from the content items 522 when the content items are delivered to the wireless end device. In one embodiment, the representation of the wireless end device displays window assignments for content items that are to appear on that device. Specifically, the user can arrange for multiple windows to appear on one end device, where each window displays content corresponding to a particular content item. The rendition of the end device in the third widow segment 516 provides a user-interface tool where, for the recently selected content item, the window assignment can be made.

Because the user has the ability to create his own recipe, service 205 may be operated to give users considerable freedom in choosing network sites from which content is to be retrieved. It is possible to operate service 205 so that the only restrictions that the user may face in being able to select content from different network sites is one placed by the service 205 for business related reasons. For example, in the case of enterprise 243, an administrator may restrict the service to sites within a particular Intranet.

Depending on the needs of the user, recipe creation may be a more sophisticated process than what is shown in FIG. 6A. FIG. 6B illustrates an interface 581 for a more sophisticated user, who wishes to create more advanced recipes. In FIG. 6B, one portion of the display represents a DOM rendition 582 of the network page. The DOM rendition 582 includes nodes 583, which correspond to content items. The nodes 583 may be organized as a tree. In the example provided, the selection of the desired content items 579 causes the node 583 of that content item to be highlighted in the DOM rendition 582. An attribute panel 585 may display attributes of the selected node. In the example provided, these attributes include a text item of the node (“Current”); the name of the parent node; the number of sibling nodes; the number of children nodes; the cell spacing; and the color of the node. By identifying nodes that correspond to content items using the aforementioned attributes, the content items can be identified at a later time, regardless of whether the content items have been changed or moved in position. Another panel 590 may show the underlying coding of the node. Once the attributes are identified, the user can select attributes that are good identifiers for the content. Content corresponding to the selected nodes may be displayed in a panel 586. The attribute selection may be based on the user's knowledge and experience. In one embodiment, the recipe creator 352 (FIG. 4) is configured to perform a test run on its ability to be able to relocate the selected content item based on the attributes selected. In another embodiment, the computer suggests the attribute selections for the recipe creator.

FIGS. 5, 6A and 6B illustrate embodiments in which the user has the ability to create recipes. A designated module, such as illustrated with recipe creator 352 on the communication application 320 may be provided for this function. In many cases, recipes already exist that the user can choose form. In an embodiment, for example, service 205 may offer the user a library of recipes. These recipes may be ones created by administrators of the service, or alternatively, by other users of the service 205. Another module of communication application 320, shown as recipe selector 354, may be used to enable users to select existing recipes from the public library.

Once the user creates the recipe, the user may be given the option of deploying the recipe for public or private use. When a recipe is created, the user may need to deploy the recipe before that user, or another user, is able to use it. If the creator keeps the recipe private, then only the creator will be able to use it. However, if the recipe is made public, then all users (subject to restrictions) may have access to it. The library may be maintained by shared memory 312. FIG. 6C illustrates an interface for enabling a user to deploy a particular recipe onto the library.

According to embodiments of the invention, users may create and maintain recipes for others. FIG. 6C illustrates an interface 542 for recipe deployment. In an embodiment, recipe deployment may be handled by the recipe deployment wizard 356 of the communication application 320. Interface 542 includes controls for users to configure, create, select and deploy recipes. A window 544 may show all of the user's recipe items 545 in selectable iconic form, which may include completed or in-progress recipes. A folder system 546 manages the recipe items 545. In the example provided, the folder list may categorize the recipe items as private, published, community or packed. Recipe items 545 may be selected, in which case an icon expression is displayed in a field 548. The user may select the icon expression, as well as its size or other features.

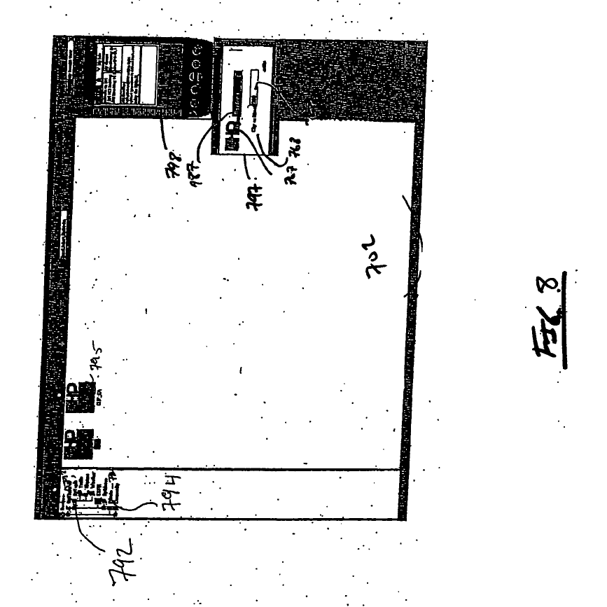

Next, the user may create the template for prompting the user to enter necessary data for executing the recipe (see FIG. 8, prompt 797). The user may create the template using field 549, which provides a user-interface for users to enter text or other indications for data fields that are to prompt users for responses. The responses will be the data entry that the recipe needs to execute properly. The user may also be provided with a list of options 543 for controlling how a particular recipe is created. For example, the user may select the recipe to work only on a fixed schedule, regardless of what another user schedules. The recipe item 545 may be locked, to prevent others from learning how it is constructed. Other fields may limit the usability or visibility of the particular recipe item 545. The recipe deployment wizard 356 may be configured to test the recipe. As such, the user may also test the recipe item 545 before deployment by actuating the deployment wizard to try out the recipe item. A test icon 551 may be used for this purpose. Another deployment icon 553 may be used to deploy a recently created recipe onto the shared memory.

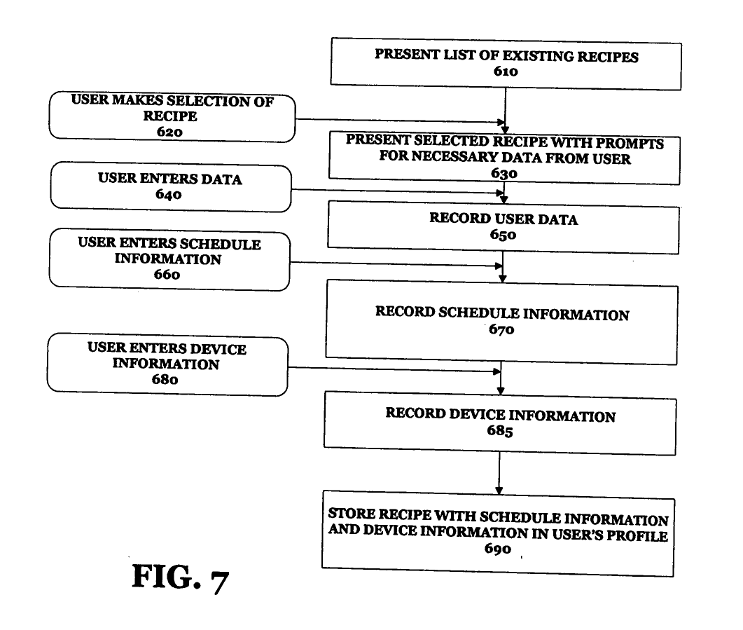

In order to retrieve content items from network sites that have existing recipes, a method such as described in FIG. 7 may be performed. In step 610, a user may be presented with a list of existing recipes. This step may be performed through the setup module 322 (FIG. 4). The setup module 322, and more specifically, the setup editor 340, may maintain all recipes in use by the user, as well as provide the user with access to the library of recipes in the shared memory 312.

In step 620, a user makes a selection of recipe from a library. Then step 630 provides that the recipe is executed to the extent needed for the user to enter necessary data so that the recipe will run correctly. For example, in the case of the user's selection being a stock quote service, the user may be prompted by the setup editor 340 to enter necessary data corresponding to stock symbols. Alternatively, the browser component 362 may render the website of the recipe, where the user's entry of data fields is recorded.

In either case, step 640 provides that data required from the user in order for the desired content items to be provided are entered. Step 650 records the data for subsequent use. This data may be stored by the setup editor 640. At a later time, the user may change the data. For example, the user may add or delete stock symbols from a list of previously entered stock symbols.

In step 660, the user specifies the schedule information, including the intervals, times, and periods on which the particular recipe is to run. Step 670 records the schedule information. In step 680, the user enters the device information, corresponding to the address of the device that is to be sent content resulting from execution of the selected recipe. Step 685 records this information and stores it with the setup editor 340. For any particular user, the setup editor 340 may associate different recipes with different end devices. For example, the user may specify different recipes for his cell phone, as compared to his PDA.

Step 690 provides that the recipe is stored with schedule information and device in formation in the user's profile. Subsequent use of the recipe may be made automatic.

FIG. 8 illustrates a user-interface from which the user may make selections of existing recipes. The interface 702 may be made available to the user through the setup module 322, and more particularly, through the recipe selector 354. Through the interface, the user may view a library 790 of recipes by category. The library 790 may include public folders 792 and private folders 794. The private folder 794 may contain a recipe that the user does not want to share with others. For example, the user may have created a recipe to retrieve content from his own bank account. The user may view folders by topic (e.g. “Traffic”, “Finance”, and “Weather”), select the desired category and view various recipe selections. In individual recipes 795 may be displayed using graphic or iconic expressions. The recipe 795 may be launched, causing a prompt 797 to appear. The prompt 797 may provide one or more data entry fields 787, 788 (or a sequence of data entry fields) and an indication 767, 768 of what is to be entered or selected for the field. The data entry fields 787, 788 may operate by pull down menu, by text entry or by various other ways of entering data into network pages. The prompt 797 requires the user to enter data that the corresponding network site requires in order to provide the desired content items.

In an embodiment, a scheduler field 772 is also provided in the prompt 797. The scheduler 772 acts as an interface to schedule manager 336 (FIG. 4). The user may enter a schedule for when content items addressed by the selected recipe are to be retrieved for delivery to the end device.

For example, in FIG. 8, traffic reports require a designation by the user of a highway of interest. This information is requested by the prompt 797. The information correlates to an action the user would have to perform if the user was to access the network site of the recipe directly. By entering the data, the user designates what field the scraper 364 must enter on the network site at schedules times. Thus, the data entry performed at this step is persistent until changed.

With respect to FIG. 8, the recipe selector 354 also executes to display on the interface 702 a rendition 798 of the user's end device. The rendition 798 may be based on information provided by the device manager 334 (FIG. 4). Furthermore, the rendition 798 may display a current state of how content appears on the device. In an embodiment, the end device is capable of displaying content from multiple network sites concurrently, in separate windows. In an embodiment, the user may arrange and configure the display of the end device, to account for size, position and content of various windows. To this end, the rendition 798 may depict the most recent window configuration on the device. Through interface 702, the user may designate a window for contents generated by the selected recipe. When the window is selected, an example of how the content is to appear in the selected window is provided.

Identifying Content Items for Subsequent and Repeated Retrieval

Network sites, particularly websites operated through third-parties, have a tendency to shift content items. For example, banner ads come and go on websites. With news sites, for example, there is no formal rules for providing content. Content providers on websites tend to view web pages creatively and dynamically. All these reasons contribute to specific content items shifting around on a given time period. For example, a business news site that offers stock quotes on one corner of the page one day may move that item to the bottom of the page on another day.

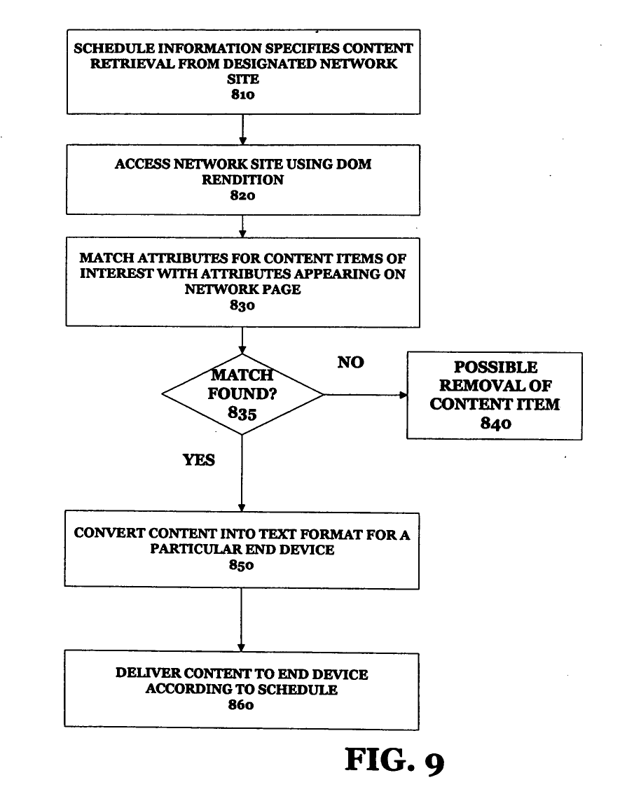

For all of these reasons, it should be anticipated that content items designated in recipes will shift around on a given network page. In order for a recipe to be effective, the recipe needs to be able to locate the content items as they are shifted around. FIG. 9 illustrates one method in which a content item that is of interest in a particular recipe can be located on a network page, even after a shift.

In step 810, content items from a designated network site are retrieved. In one embodiment, the scraper 355 is prompted, by schedule information such as maintained by schedule manager 336, to access a selected network site for purpose of retrieving the desired content items.

Step 820 provides that a network site is viewed using its DOM rendition. The scraper 355 may view the DOM rendition of the particular network site.

In step 830, the attributes stored for content items of interest are compared with attributes that appear on the particular network page. The comparison may be in the form of determining if a set of attributes for a particular node on the network page is a substantial match to the stored attributes.

In step 835, a determination is made as to whether a match had been found. In one embodiment, a 90% correlation may be sought between the stored attributes and what is provided on the network page.

If no match is found, step 840 may result in some action that indicates the possible removal of the desired content item. The action may be intended to prompt the user to check the network site of interest in order to relocate the content item. This action may correspond to an error message, or some non-delivery of content to the end device at a scheduled time.

In step 850, the desired content items on the network page are converted into a format for a particular end device. In an embodiment, the desired format is a text-based format, although other embodiments may provide for the delivery of media, and in particular, of images and graphics.

In step 860, content based on the content items is sent to specified end devices according to schedule.

Content Delivery

As discussed above, users of service 205 may select content items on network sites, specify a schedule for when those content items are to be retrieved, and specify end devices that are to receive the content items. From there, service 205 performs steps for locating the content item, formulating content messages based on the content items, and sending the content items to the specified end devices. In one embodiment, the service application 324 performs most, if not all of the steps in sending the content messages to the end device. This functionality may be performed automatically, without the need for providing any user-interface.

A general goal of any network communication is to limit the amount of bandwidth used for a particular communication. Wireless networks in particular are limited in bandwidth and can be expensive to use, especially when large amounts of data are being sent on the network. Accordingly, embodiments of the invention provide a technique for reducing the amount of bandwidth needed to send content messages to end devices.

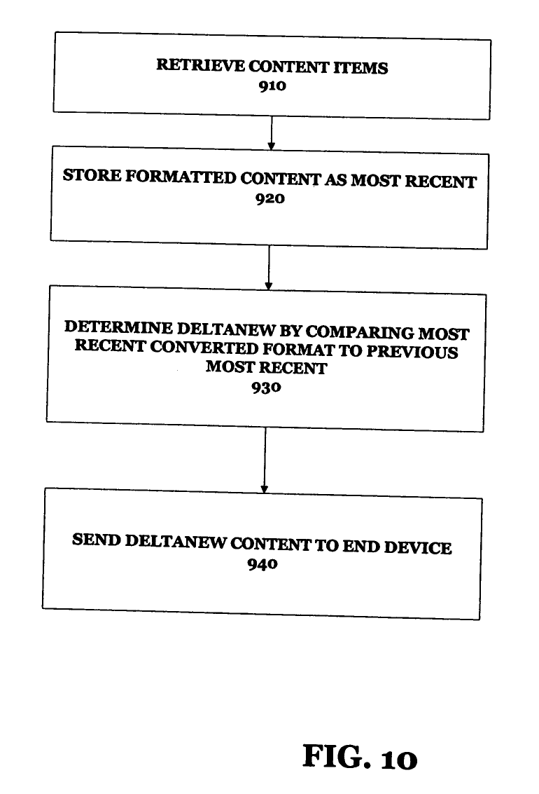

FIG. 10 illustrates one technique for reducing bandwidth when sending content messages, under one embodiment of the invention. In describing steps of the method, reference may be made to elements in system shown with other figures. Such reference is intended to be illustrative of a suitable component or environment for implementing the step or method.

Step 910 provides that content items are retrieved. In a system such as described with FIG. 3, service 205 may execute a recipe in order to locate specific content items of interest, on a designated network site. Scraper 355, may be prompted by a recipe stored in a user's profile to access the designated network site and locate content items of interest from that site.

Step 915 provides that content messages are generated from the content items. In one embodiment, scraper 355 removes text-based content from a copy of the content items. This content is formatted using an SMS protocol, so as to have a limited block size and characteristic data structures. The content messages may then transmitted to specified end devices using the wireless network, which may include transmitting the messages to an uplink first.

Prior to transmitting the content messages, an embodiment provides in step 920 that the content messages are stored and identified as most recent. In one embodiment, resource from an access terminal 210 is used to store the content messages on the service 205, although it is also possible to store this content history on the access terminal 210 of that user. Furthermore, it is possible for the content items in their copied form, or some derivation of the content items to be what is stored, as opposed to the content messages.

Retrieved content items may be either new, or have history. In either case, step 930 provides that a difference between the most recent content item (or new) and the previous most recent content item (or none at all) is determined. This difference is referred to as a “deltanew”. In short, the deltanew is detemined between the most recent content messages (“MRCM”) and the previous most recent content messages (“PRCM”). In one embodiment, deltanew is determined by obtaining a difference of binary values for the contents of MRCM and PRCM respectively. A resulting binary value corresponding to the difference between MRCM and PRCM is formulated.

Step 940 provides that the content message is transmitted to the specified end device. This content message may be received by the end device, and existing content that corresponds to the content message may be altered or updated to reflect the change provided in the content message. The resulting content message may comprise the binary value representing the difference between PRCM and MRCM, as well as an identifier of the end device. The binary format of the content message may be processed by the end device so that deltanew is incorporated or integrated into the content appearing on the end device. The binary format of the content message enables the end device to locate the specific set of pixels or screen elements that deltanew is to alter.

To provide examples, text data may be replaced in part by new text that represents an update. For example, if the content on the end device is ABCD: 17.5 (corresponding to a stock quote for company “ABCD”), the “deltanew” may be an updated stock price of ‘7.8’. The end device may accept this change and provide updated content in the form of ABCD: 17.8. Similarly, graphical content on the end device may be updated in the same manner. An update content delivery for a five-day chart of a stock quote, for example, may cause the content appearing on the end device to be ticked slightly to reflect a most recent closing stock price for a company, and the previous four days may be moved back. But the company name and the axes of the chart may remain static.

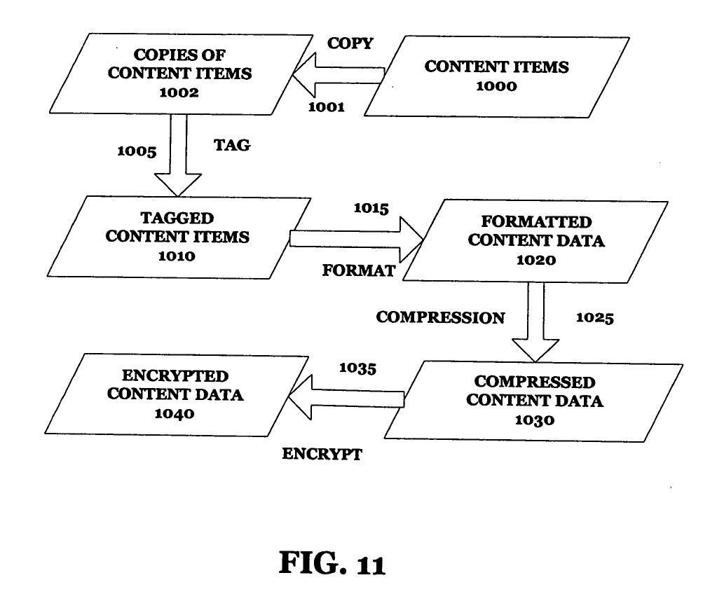

FIG. 11 illustrates processes that are performed under an embodiment in taking selected content items from a designated network site. Initially, a copy operation 1001 is performed on selected content items 1000 to yield copied data 1002, which may be displayed on a corresponding network site.

A tag operation 1005 to designate window placement is performed on the copies of the content items to yield tagged content items 1010. When a content item is selected for the first time, one embodiment provides that the user may select a window or screen location on the end device for content based on those content items. In an embodiment such as shown by FIG. 6, the user may designate window location of an end device using the device's rendition in the third segment 516 (FIG. 6). This user-action is then interpreted as a selection of a window that is to carry the content on the end device. Once the user makes a selection of a window for content based on a designated content item, the content data derived from those content items is tagged to identify that window for that content on the end device.

According to an embodiment, a format operation 1015 may be performed on the tagged content data 1010, resulting in formatted content data 1020. In one embodiment, the format operation 1015 is a simple removal of graphics, rich media and other non-text items. As such, the formatted content data 1020 is primarily text, although the tag information for placement of the content on the end device is preserved.

A compression operation 1025 may be performed on the formatted content data 1020 to yield compressed formatted data 1030. In an embodiment such as described with FIG. 10, the compressed formatted data corresponds to “deltanew”. Tag information for locating a window on the end device is preserved with this operation. In an embodiment, the compressed data may be tagged in operation 1025.

Next, compressed content data 1030 may be subjected to an encryption operation 1035, yielding encrypted content data 1040. The encrypt operation 1035 may include a secondary compression operation.

With reference to FIG. 11, the particular sequence or manner that operations are performed may be flexible. For example, the tag operation may be performed before or after the format operation. In addition, certain operations, such as the encrypt operation 1035, are optional.

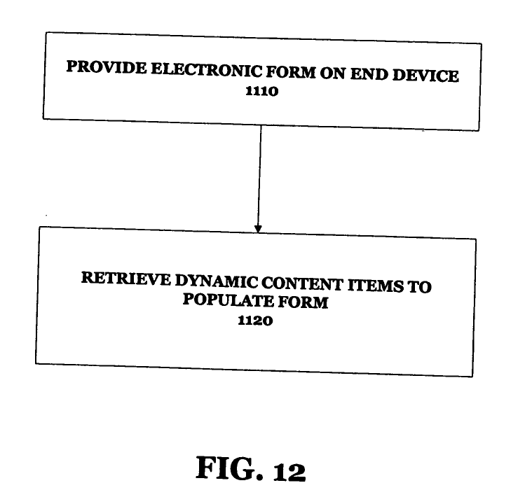

FIG. 12 describes one technique for compressing and/or encrypting data. In step 1110, a user is provided an electronic form on a designated end device. In one implementation, the electronic form corresponds to a portion of a content item that is designated to be static. The form may be provided through a secure download or transmission, or some other means.

After the end device is provided with the electronic form, step 1120 subsequent retrievals of the content items are performed to yield changes in the content that exclude the electronic form. Thus, dynamically updated content items that appear on a network site may be identified separately from static data. Consequently, the derivation of “deltanew” by the service in subsequent retrievals does not yield any change to the structure of the form as it appears on the device. While one embodiment describes that the form is provided to the end device at the first retrieval, another embodiment may provide for the form to be downloaded directly onto the end device.

As an example of how an embodiment may be implemented, in sporting events, the electronic form may be the structure of a tournament bracket. As content items are refreshed on the network site, the form is not changed on the network site.

An embodiment such as described in FIGS. 9-11 also has applications to the retrieval and transmission of secured data. A user may wish to retrieve content items that are secured, such as checking account information. Certain content items on a page where the checking account information is rendered may be sensitive, and require strict security. When these items are static (not subject to change), they may be treated as an electronic form, such as described in FIG. 12. This means that the information would be provided on the wireless device one time. Because only the deltanew is transmitted with subsequent retrievals, the sensitive information is never included in the transmissions. This allows the user to maintain secure data fields on an interface of the end device without having to transfer those data fields, while also having the interface reflect the same content as the network site. Examples of secure data fields that can be presented with data that is updated with wireless transmissions include checking account number and amount, ticker symbol and share price, and purchase account number and activity.

In order to maintain secure data as part of a form on the end device and have non-secure data transmitted by scheduled retrievals, a user may want to use or create a recipe where the dynamic, non-secure data items are identified. Implementation of this recipe ensures that the transmissions to the end device include only the dynamic, non-secure items.

In one embodiment, it is possible for a data structure appearing on a network site to include a data structure that is secure and dynamic, but have portions of that data structure that are static. For example, a user may recognize that the amount in his savings account will be an amount that starts with “$11,” for the foreseeable future. The total amount may be a number that is more than $11,000. The user may be able to create a recipe where the secure content item is “$11,” and the non-secure item is the portion of the data structure following “11,”. Should the savings account go under $11,000 or more than $11,999, an error message would result. What ends up being transmitted as deltanew, however, is a three-digit number that would be meaningless to anyone but the holder of the end device.

Tagged Content

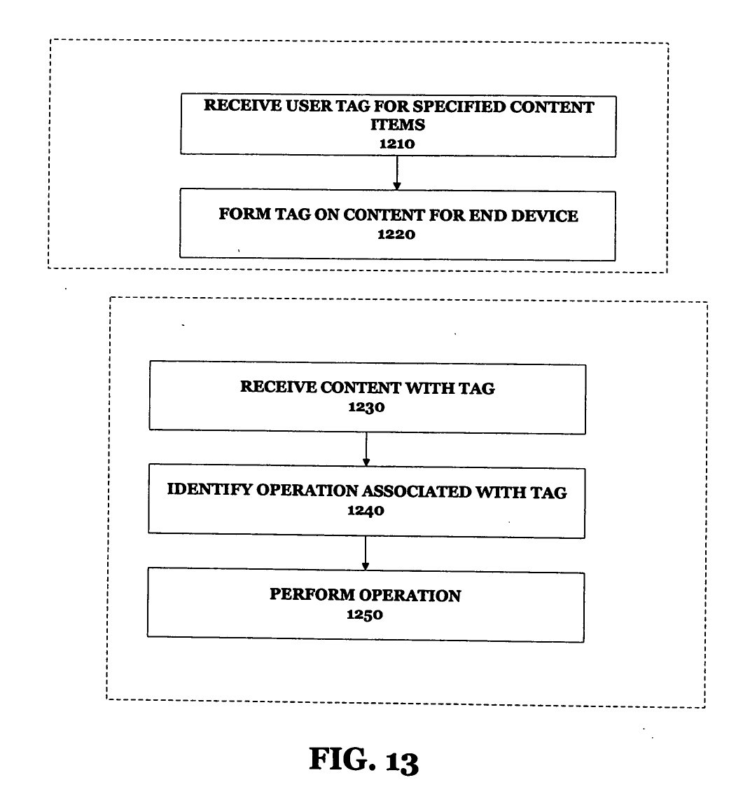

FIG. 13 illustrates a method by which content may be tagged so that its delivery on an end device results in the end device performing some designated action on that content. In one embodiment, the end device categorizes the content on receipt. In such an embodiment, the tagged content enables content send to end devices to be categorized on that device. The categorization may be based on various types of categories.

The service 205 (FIG. 3) receives user tags for specified content items. Various mechanisms may be implemented for users to enter tags for specific content items. In one embodiment, when the user selects a recipe in interface 702 (see FIG. 8), the user has an opportunity to associate the selected content item with a window on the rendition 798. For example, by clicking the content item, then clicking a window corresponding to a screen segment on the rendition 798, the user associates content from that content item with a window on his end device. The tag is then set. Alternatively, service 205 may generate tags programmatically on factors such as importance, content, or user specifications.

In step 1220, content derived from the content items is associated with the tag. For example, content messages 126, 128 (FIG. 2) may be tagged. The tags may be in the form of a text string that appears on the subject line of the content messages.

On the device, step 1230 provides that content messages are received with tags. In step 1240, the end device identifies some operation that is associated with the tag. In step 1250, the associated operation is performed. The operation may correspond to an application that is to receive data from the content message. For example, in one embodiment, a memo pad application receives content from a particular content message, while another tag may designate that content from another content message goes to a note pad application. Another embodiment designates an order or sequence in which content is to be rendered on the end device, based at least in part on the tag.

According to one embodiment such as described above, a tag on a content message designates what window content from that message is to be rendered in. As will be described, the end device may be configured with a client application to be able to render content on multiple windows, at the same time.

Content Reception

Embodiments described herein provide that the end device can concurrently display multiple windows, where each window includes content from a corresponding source, and in particular, from a network source. Embodiments such as described may have added benefits in the context of wireless communications. In one embodiment, a wireless end device may detect transmission of data corresponding to a particular content item. A source of the particular content item may be identified, where the source corresponds to one or more network sites. For example, as described with other embodiments, the source may be identified by the end device with the inclusion of a tag in the data transmission. Content that is at least partially generated by the data transmission may be positioned on a display area of the end device based on the source of the content item.

To provide an example, the user may specify a first display area (such as a window) for financial information, and a second display area for sports information. When data is transmitted, the end device identifies whether the data is based on content items belonging to the financial or sport network site. The end device then updates content in the corresponding window or display area.

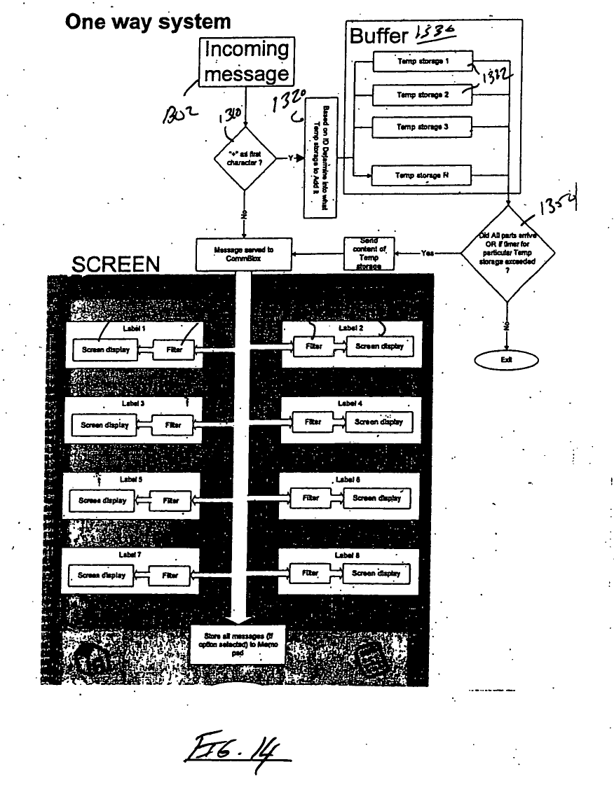

FIG. 14 illustrates a technique for rendering content form an incoming content message, under an embodiment. A method such as described in FIG. 14 may be performed on the end device.

An incoming message 1302 may be received and inspected on the end device. As part of the inspection, the end device determines if the content is part of a bigger message. As indicated by step 1310, some identifier (e.g. “+”) may be provided in the content message to indicate that the message is part of a larger message. An identification of the message is determined in step 1320. Based on the identification, the message is forwarded to one of many possible temporary memory spaces 1322 in a buffer 1330. When a detection is made that one of the memory spaces 1322 is filled, a determination is made in 1350 that the message is complete. If a time out occurs, 1350 may determine that the message was dropped.

A completed message may include a tag, which in one embodiment, corresponds to an identification in its subject line. The completed message may be passed through a process flow, where the tag is matched to a filter 1360 of a corresponding window 1362. In one embodiment, the filter 1360 is matched to the tag at the step of recipe selection. When the filter and tag match, the content from the message is rendered on the corresponding window 1362.

As an alternative, a content message may be sent to an application, such as “memo pad”.

According to an embodiment, third-party content messages may be received and rendered in separate windows, or processed in a manner described with FIGS. 12 and 13. Such content messages from third parties may carry identifiers in their subject headings which the user may select as a tag. When the tag is selected, all incoming messages that have that tag are treated the same, whether it is to render content from that message in a particular window, or whether an operation or action is to be performed.

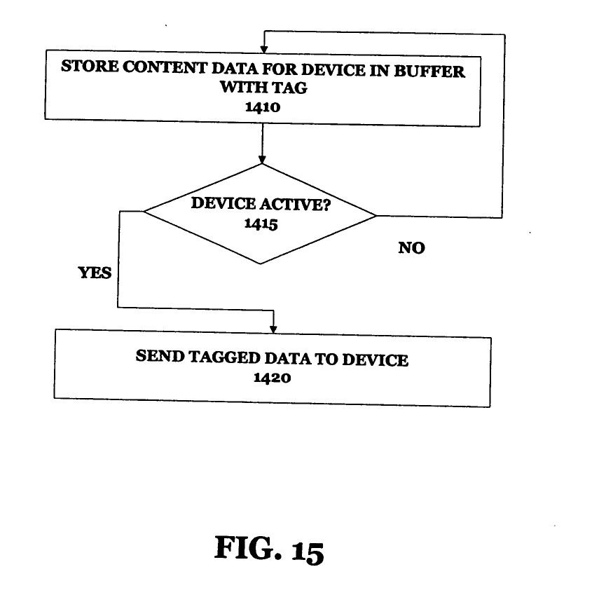

FIG. 15 illustrates a method where tagged content may be delivered to a device that is not always active, under an embodiment. Step 1410 of such a method provides that when tagged content messages are generated for a particular end device, the content messages on a server-side buffer. Step 1415 provides that a determination is made as to whether the end device is active or available, which may mean whether the device is on. If the device is not active, it service 205 (FIG. 3) waits until activation occurs. Activation may be detected because the end device registers with an uplink server or base station upon activation. When this occurs, tagged content data is pushed to the end device. The tags of the content messages let the end device know what to do with the content, even thought the content was sitting in the buffer and the end device and service 205 are not in direct communication.

User Interface on End Device

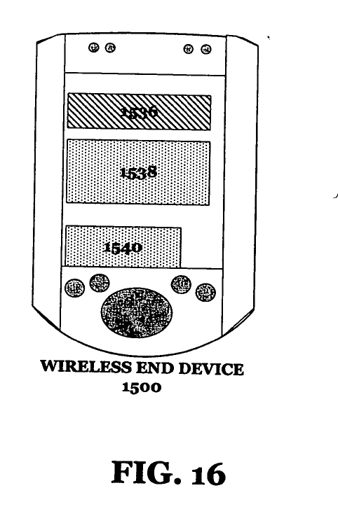

As described above, content messages 126, 128 (FIG. 2) are rendered on a end device 1500 concurrently. FIG. 16 illustrates an end device configured so that a content message 126, 126 can be rendered on a corresponding window. In an embodiment such as shown, each window is a portion of a screen display or segment. A first window 1536 shows content originating from a first content item at a first network site, a second window 1538 shows content originating from a second content item at a second network site, and a third window 150 shows content originating from a third network site. In one embodiment, the content for each window is retrieved according to its own schedule, and under its own recipe.

End device 1500 may be configured with a client application to provide the multi-window display and to process incoming messages to appear in designated windows (such as through tags). The configuration of end device 1500 may permit the windows 1536, 1538, 1540 to be resized, repositioned, removed or added on to. Thus, an embodiment provides that the arrangement, number, and size of the windows is configurable by the user. Because tags may be used, the position of the window is not pertinent for the end device to determine where content from a particular content message is to be rendered. Each window may be dragged and moved and content appearing in those windows is moved with it.

An embodiment also contemplates that one or more of the windows 1536, 1538, 1540 display local content. For example, a user may store a photograph on the end device, and one window may display that photograph, while the other windows display the network content and are updated.

According to one embodiment, the client application on which windows 1536, 1538, 1540 is assigned to the actuation of an input mechanism of the end device 1500. This may correspond to actuation of a button, an icon, or the entrance of a stroke onto the contact-sensitive display. The association of an application to a button or input is known in the art.

According to an embodiment, each window 1536, 1538, 1540 may carry functionality. In the case where end device 1500 has a touch-sensitive display, contact with the display at a region corresponding to a particular window may invoke the end device 1500 to perform some function. One function may be to enlarge the window (e.g. tap once), another function may be to reduce the window. Still further, a tap on one side of the display may invoke one type of functionality, while a tap on another side of the window may invoke another functionality.

While end device 1500 is shown as a PDA, other embodiment may provide for other types of devices, such as cellular phones, music players with wireless functionality, and computer systems integrated into automobiles and home appliances.

A client application operating on the end device 1500 may also be equipped to communicate with the service 205 (FIG. 3), so that a 2-way communication channel is achieved. The user may, for example, reconfigure an aspect of how the service 205 pushes data to the end device 1500. For example the user may adjust the schedule for content that is sent to a particular one of the windows.

Revenue Models

Embodiments of the invention enable various revenue models for a system such as described. Under one embodiment, service 205 is subscription based for all end users. In another embodiment, the service 205 may be operated by enterprises, who pay for service 205, and the ability to provide content to users of the enterprise network.

According to another embodiment, a shared architecture model may be implemented. Under such an architecture, certain users of service 205 also provide their computers to be part of the service 205. In one embodiment, these users may correspond to recipe creators, who pay consideration for service 205 to make their recipe available to the public. Since recipe creators may spotlight items on their network sites to users, recipe creators may benefit from having as many users implement their recipe as possible. For example, an online travel site may provide a recipe for a fare finder, where end users can implement the recipe to have message alerts of their choosing for particular fares or travel news. As another example, an online auction site may provide recipes for enabling users to monitor certain auctions. In either one of these cases, at least part of the consideration for service 205 offering the recipe is that the recipe creators have to make computer resources available for the service.

When a recipe is created, the act of maintaining the recipe itself requires effort and expertise. For example, content items may shift on network sites dramatically, both in position and in configuration, so that a particular recipe becomes useless. Accordingly, one embodiment enables service 205 to charge for the maintenance of recipes in the public library.

Additional Applications

Numerous extensions and applications may be provided, based on embodiments described above. One type of application is messaging. Currently, network messaging applications exist in the form of emails, and instant messages, including text messages and data attachments that can be sent with such messages. For more sophisticated users, additional messaging applications include voice messaging and video conferencing, using networks such as the Internet. Messaging accounts generally have an identification, and in most cases, are remotely accessible. In one embodiment, recipes can be created to access messaging accounts using such identifications. As discussed previously, in the case of POP3 email accounts, the location of the email service may have a web address or URL, to which the recipe must provide login and password. In the case of client or enterprise messaging accounts, the location of the messaging service may be needed, such as the domain of the incoming or outgoing server. In addition, the recipe may need to provide the password and login of the specific account in question, along with directions on how to locate and remove/copy messages from an inbox. An interface for capturing a user's browsing activity may also be provided on, for example, a desktop computer, in order to enable the user to have local browsing actions (actions for the user's terminal programs), as well as other user-interface activities (graphic user-interface input, keystrokes etc.) be recorded and accessible to one or more recipes at a later date.

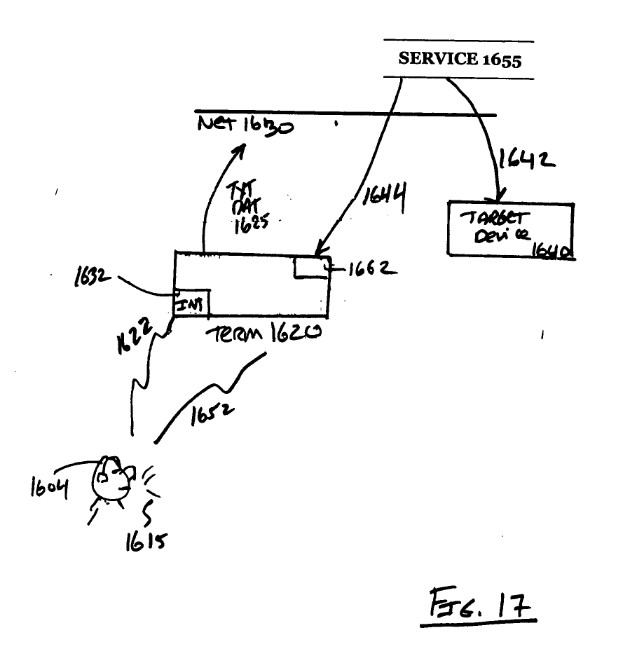

In a system such as described by FIG. 17, a user may record speech or voice from the terminal 1610, and cause data representing the speech or voice to be sent to the target device 1620. In an embodiment such as shown, the target device corresponds to a cell phone. For example, in one embodiment, a user may utter speech through a microphone/headset 1604 connected to the terminal 1620 via a high-speed connection 1622, such as Bluetooth. The microphone/headset 1604 may capture the speech and send corresponding speech data 1622 to the terminal 20.

A speech-text interface 1632 (such as provided by a commercially available application) may capture the speech 1615 and convert it to text data 1625. The text data 1625 may be sent to network 1630, or alternatively made available over that network. For example, the text data 1625 may reside in a messaging account. A recipe may be created and stored for the user to retrieve messages from the account where the text data 1625 is stored. For example, the text data 1625 may be provided in the inbox of a POP3 email account on the network 1630, or on an enterprise email account on the terminal 1610.

A service 1655 (which may operate similar to embodiments such as described above; e.g. see FIG. 2) may execute the recipe and send content data 1642 to a target device 1640. The recipe may be configured to enable retrieval of the message that contains the text data 1625, as well as delivery of data 1635 corresponding to the text data to a target account. Alternatively, an application on the terminal 1610 may be configured to send the text data 1625 to a web-site, such as a web blog, and a recipe may retrieve the data from that site. In another embodiment, terminal 1620 sends the text data 1625 to a network location hosted or otherwise accessible to the service 1655. The service 1655 may be configured to check and apply recipes on the fly when such data is generated and received. Still further, the recipe may enable service 1655 or an equivalent to access the terminal 1610 when text data 1625 is generated, so that service 1655 can send content data 1642 to the target device 1640. In one embodiment, the content data 1642 is based on the speech. In another embodiment, the speech only issues instructions that identify what recipe, network site, or content data to send to the target device.

One application for an embodiment such as described in FIG. 17 is a user who uses a wireless headset to utter speech input. A standard speech-to-text program (acting as interface 1622) may convert the speech to text, and the text may be transmitted to a location available to service 1655. In one embodiment, a recipe may be executed to convert the text data to content for the target device. Alternatively, the recipe may be used to prompt service 1655 to retrieve content from a particular network site and/or set of content resources. In either case, content data corresponding to or specified by the speech input is sent to the target device 1640. A Bluetooth or WIFI connection may enable the user to walk about using microphone/headset 1604 in a set range from terminal 1620, while sending his speech data to the terminal 1620.

As an alternative to an embodiment shown in FIG. 17, content data 1642 may be in the form of audio, rather than text. In one application, audio content data may be generated and formatted based on speech data 1622. In another application, the speech input causes the recipe 1655 to call a recipe that extracts content items from a particular network site. The service 1655, or some other location, may then convert data representing the content items to audio content data. In one embodiment, the audio content data may be sent to the target device after a conversion process to break and/or format the audio content into one or more messages (e.g. SMS messages). Thus, there may be no need for a conversion into text-based data.

Another application for an embodiment such as shown in FIG. 17 includes enabling speech input to prompt delivery of network content in audio form, where the speech input and audio output are from the same device, or from the same proximity or general location. For example, one embodiment provides that the recipe called in service 1655 identifies terminal 1620 as the target device. Content data 1644 may be transmitted to the terminal 1620. A conversion application or interface 1662 may convert the data from service 1655 into audio content data 1652. The audio content data 1652 may be transmitted (via e.g. WIFI or Bluetooth) to microphone/headset 1604 (which includes speakers). Audio output may be provided to the user based on the audio content data 1652, where the audio output corresponds to network content specified by the recipe used by the service 1655.

The particular recipe used may be selected based on the origin of the terminal 1620, or based on the commands specified in the speech data 1622. For example, since terminal 1620 sends data to service 1655, a particular recipe may be selected. Alternatively, the speech to data interface 1632 may identify commands that select the particular recipe for the user.

Still further, the target device 1610 may correspond to a device that is held by the user. For example, in scenario, the user holds a cell phone that corresponds to target device 1610. Content data 1642 is transmitted to the cell phone as text or audio, depending on the application.

In another embodiment, the terminal 1620 and target device 1610, and possibly the microphone/headset 1604 may be part of one multi-function device, or part of one platform that operates on two or more integrated devices. The integrated devices may, for example, operate under a common operating system. For example, microphone/headset 1604 and target device 1610 may be a cell phone, which has Bluetooth capabilities to communicate with terminal 1610. Various other combinations are contemplated and possible.

Two-Way Recipe Configuration or Control

Embodiments described above provide that a primary role of a target device as being receiving data or content. However, it is also possible for the target device and service (such as service 205 in FIG. 2) to exchange communications that originate from the target device. In particular, input may be provided from a user of the target device in relation to the content provided by service 205 to that target device. This input may, for example, be used to affect the use of one or more recipes by the service and the target device.

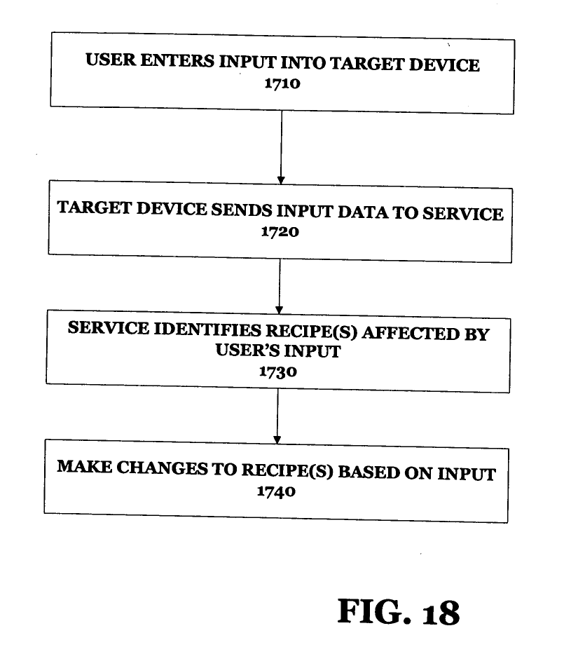

FIG. 18 illustrates an embodiment in which the target device is capable of entering input that is received and processed by a service, in order to affect a manner in which the service provides content data to the target device.

In step 1710, a user enters an input on the target device. The input may, for example, be directed to the user or operation of one or more recipes. For example, the user may enter the input with the intent of changing the schedule or timing pattern used by a recipe, or change the data parameters used by the recipe (e.g. change stock ticker symbol). Alternatively, the input may be directed to a recipe manager (such as recipe selector 354 in FIG. 3) in order to direct the recipe selector to select a new recipe, modify an existing or in-use recipe, add a new recipe from a library, or create a new recipe.

In step 1720, the target device sends data corresponding to the input to the service (see, as example, service 205 in FIG. 2). In one embodiment, a traditional web connection may be formed between the target device and the service. For example, a wireless target device may access service 205 using a narrow bandwidth wireless data channel, and then manipulate or enter input using the standard wireless browser. Alternatively, a message (such as an SMS message) containing data that is then received by the service and processed as instructions may be used.

The input entered may be specific for the target device's recipe or recipe library. Step 1730 provides that service identifies one or more recipes that are to be affected by the input. For example, the user may tap or open a window where content from a particular network site is received. Once the window is open, the user may be prompted or otherwise provided an interface for sending an input. The input is tagged with the identification of the window, so that when the input is received on the service, it is identified as pertaining to the recipe corresponding to the open window.

As an alternative, the user's input may be for affecting a class or multiple recipes in use. For example, the user may wish to slow down all content retrieval to conserve battery life. In this case, the service may identify all recipes in use for the target device when applying the input. Still further, the input may be pertinent to a recipe that is not in use for the user (e.g. it may be in the public library). The input may also be to reconfigure or make a non-operable recipe (or even a non-existing recipe) executable for the particular target device.

In step 1740, the service 1655 makes changes to the recipe's that are pertinent to the input, based at least in part on the input. In one embodiment, deletes (or stops using) or edits one or more recipes in use. Alternatively, a recipe not in use is made in use. Still further, recipes in use may be reconfigured. In particular, the timing or schedule may all be reconfigured or reset. The data parameters used by the identified recipes may also be changed. Once changes are made to the recipe(s) pertinent to the input, the operation of the service and target device may be resumed, with consideration to the input.

### Alternative Embodiments

While many examples and embodiments described herein recite wireless end devices as target devices for receiving network content, other embodiments may use other types of network enabled devices. For example, one embodiment contemplates use of a small network appliance that can benefit from receiving network content in a compressed and stripped down form. Another embodiment contemplates a network device having a small screen, so that network content is best rendered in text or stripped down form. Still further, other examples for the target device include a personal computer or web-based television.

While a focus of many embodiments described herein is a cellular phone or wireless PSA, it should be noted that other wireless target devices are contemplated by embodiments of the invention. Examples of other devices contemplated include mobile computers provided in vehicles or on airplanes.

While various embodiments describe the delivery of text-based content data, it is possible for other forms of data to be sent to a target device. In particular, voice messages and audio blurbs are contemplated, as well as images or even video clips. An embodiment provides that audio, image or video messages are sent in a series of messages that are received and compiled on the target device. For example, an audio content item can be recreated on the target device using the payload of a series of SMS messages.

With reference to an embodiment such as shown in FIG. 17, the speech data may, for example, by pass text-conversion, or undergo another kind of conversion where audio data is reformatted into messages (like SMS messages). Data is then send to the target device that recreates the speech of the user.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

1. A method for providing network content on a mobile device, the method comprising:
detecting transmission of data corresponding to a particular content item;
identifying a source of the particular content item;
displaying a content based at least in part on the data;
wherein the step of displaying the content includes positioning the content on a display area of the mobile device based on the source of the particular content item.

2. The method of claim 1, wherein the step of positioning content on a display area includes selecting a segment that forms only a portion of the display area.

3. The method of claim 1, wherein identifying a source of the particular item includes identifying a network site on which content items that include the particular content item are provided.

4. The method of claim 1, wherein the step of detecting transmission of data corresponding to a particular content item includes detecting a wireless communication addressed to the mobile device.

5. The method of claim 4, wherein detecting the wireless communication includes detecting a text-based message transmission.

6. The method of claim 5, wherein displaying a content includes displaying text.

7. The method of claim 5, wherein the text-based message transmission corresponds to a short message service (SMS) format.

8. The method of claim 1, wherein displaying a content includes performing an operation to derive the content based on the data.

9. The method of claim 8, wherein detecting transmission of data includes detecting transmission of text-data, and wherein the step of performing the operation includes converting the text-data into a graphical representation.

10. The method of claim 1, wherein the step of displaying a content based at least in part on the data includes performing an operation on the data in order to display the content.

11. The method of claim 10, wherein the step of performing the operation includes formatting the data for one or more of the particular display segment and the display area of the mobile device.

12. The method of claim 10, wherein the step of performing the operation includes sizing the content for the particular display segment.

13. The method of claim 12, wherein the step of sizing the content includes providing only a portion of the content to be viewable at a given instance, and enabling the user to manipulate the mobile device to view a remainder of the content.

14. The method of claim 13, wherein the step of enabling the user to manipulate the mobile device includes displaying at least a portion of the remainder of the content in response to a user causing contact with the display area.

15. The method of claim 10, wherein the step of performing an operation includes identifying text data from the transmitted data.

16. The method of claim 10, wherein the step of performing an operation includes performing a conversion operation to present the content in a graphical form.

17. The method of claim 1, wherein the step of displaying a content based at least in part on the data includes interactively displaying the content so as to be responsive to user-input.

18. The method of claim 1, wherein the step of detecting transmission of data corresponding to a particular content item includes detecting a message sent to the mobile device.

19. The method of claim 18, wherein the message is addressed to an email address of the mobile device.

20. The method of claim 19, further comprising detecting a plurality of messages sent to the mobile device, and wherein the step of detecting transmission of data corresponds to combining data provided by each of the plurality of messages.

21. The method of claim 20, wherein each message is transmitted using a short message service (SMS) format.

22. The method of claim 1, wherein the step of identifying a source of the particular content item includes identifying a tag associated with the content item, wherein the tag is generated by a service that retrieves the particular content item from a corresponding one or more network sites.

23. A method for providing network content on a mobile device, the method comprising:
designating individual segments of a display area for the mobile device to a corresponding source of content items;
detecting transmission of a first set of data corresponding to a first content item;
identifying a source of the first content item;
determining that a first one of the individual display segments in the display area is designated for the source of the first content item; and
displaying a first content based on the first set of data on the first display segment.

24. The method of claim 23, further comprising the steps of:
detecting transmission of a second set of data corresponding to a second content item;
identifying a source of the second content item;
determining that a second one of the individual display segments in the display area is designated for the source of the second content item; and
displaying a second content based on the second set of data on the second display segment.

25. The method of claim 24, wherein the step of displaying the second content based on the second set of data includes displaying the second content in the second display segment concurrently with displaying the first content in the first display segment.

26. The method of claim 25, wherein the first display segment and the second display segment form only a portion of display area.

27. The method of claim 23, further comprising the steps of:
detecting transmission of a third set of data corresponding to a third content item;
identifying a source of the third content item;
determining that a third one of the individual display segments in the display area is designated for the source of the third content item; and
displaying a third content based on the third set of data on the third display segment.

28. The method of claim 27, wherein the step of displaying the third content based on the third set of data includes displaying the third content in the third display segment concurrently with displaying the first content in the first display segment.

29. The method of claim 23, wherein the source of the first display segment is a network site.

30. The method of claim 24, wherein the source of at least one of the first and second display segment is a first network site and a second network site respectively.

31. The method of claim 23, further comprising the step of enabling a user to configure one or more of the individual display segments.

32. The method of claim 31, wherein the step of enabling the user to configure one or more of the individual display segments includes enabling the user to select a size of each of the display segments.

33. The method of claim 31, wherein the step of enabling the user to configure one or more of the individual display segments includes enabling the user to select an arrangement for how each display segment is to be positioned with respect to other display segments on the display area.

34. The method of claim 24, wherein at least the step of displaying a second content based on the second set of data is performed independently of displaying a first content based on the first set of data.

35. The method of claim 24, wherein the step of detecting a first set of data is performed at a first instance of time, the step of detecting a second set of data is performed at a second instance of time that is different than the first instance of time, and wherein the method further comprises the steps of:
detecting transmission of a third set of data corresponding to one of an updated first content item or updated second content item;
identifying the source of the one of the updated first content item or updated second content item; and
updating one of the first content or second content by
if the third set of data corresponds to the updated first content item, then updating the first content on the first display segment,
if the third set of data corresponds to the updated second content item, then updating the second content on the second display segment.

36. The method of claim 35, wherein the step of updating the first content or second content includes updating the first content while displaying the second content and not updating the second content.

37. The method of claim 35, wherein the first content item and the updated first content item originate from a first set of one or more network sites, and wherein the second content item and the updated second content item originate from a second set of one or more network sites.

38. The method of claim 24, wherein the steps of detecting transmission of a first set of data and detecting transmission of a second set of data includes:
receiving a plurality of messages on the mobile device; and
sorting the messages so that at least (i) a first set of one or more messages is identified to correspond to the first set of data, and (ii) a second set of one or more messages is identified to correspond to the second set of data.

39. The method of claim 38, wherein each of the first set of one or more messages and the second set of one or more messages is addressed to an email address of the mobile device.

40. The method of claim 39, wherein each message is transmitted using a short message service (SMS) format.

41. A method for providing network content on a mobile device, the method comprising:
copying content items provided at a plurality of network sites, including copying at least a first content item from a first network site and a second content item from a second network site;
generating data corresponding to the copies content items, wherein said data includes data (i) identifying a source of the first content item as the first network site, and (ii) identifying a source of the second content item as the second network site;
messaging said data to the mobile device.

42. The method of claim 41, wherein the step of copying content items provided at a plurality of network sites includes copying the content items according to a schedule specified by a user of the mobile device.

43. The method of claim 41, wherein the step of copying the content items includes copying text-based content.

44. The method of claim 41, wherein the step of generating data corresponds to generating data to provide only text from the first content item and the second content item.

45. The method of claim 41, wherein the step of copying content items provided at a plurality of network sites includes using identification information to locate the content items on the plurality of network sites independent of knowing a position of the respective content items.

46. The method of claim 45, wherein the step of using identification information includes using information provided by the user of the mobile device.

47. The method of claim 45, wherein the step of using identification information includes using a recipe that provides said identification information.

48. The method of claim 45, wherein the step of using identification information includes accessing a library on which a plurality of recipes are stored, and using a plurality of recipes that provide computer-implemented instructions for locating each of the content items provided at the plurality of network sites.

49. The method of claim 41, wherein the step of messaging said data includes segmenting said data into a plurality of data blocks, and sending each of the plurality of data blocks as a separate message.

50. The method of claim 41, wherein the step of messaging said data includes using an email address of the mobile device.

51. The method of claim 49, sending each of the plurality of data blocks as a separate message includes sending each message as a short message service (SMS) message.

52. A mobile computing device comprising:
a communication port to receive communications from over a network;
one or more processors configured to:
detect transmission of data corresponding to a particular content item;
identify a source of the particular content item;
cause a content based at least in part on the data to be displayed on a display associated with the mobile device;
wherein the processor is configured to position the content on the display based on the source of the particular content item.

53. The mobile computing device of claim 52, wherein the communication port is configured to receive the communications wirelessly.

54. The mobile computing device of claim 52, wherein the communication port is configured to receive the communications through a cellular network.

55. The mobile computing device of claim 54, wherein the communication port is configured to receive the communications as a series of short message service (SMS) messages.

56. The mobile computing device of claim 52, wherein the display is integrated with the device.

57. The mobile computing device of claim 56, wherein the display is contact-sensitive in order to receive user-input for affecting operations of the processor when displaying the content.

58. The mobile computing device of claim 52, wherein the one or more processors position the content by assigning a portion of the display to the content.

59. The mobile computing device of claim 59, wherein at least one of a size and a location of the portion of the display are determined by a user-input.

60. The mobile computing device of claim 52, wherein the one or more processors cause the display of the content concurrently with causing the display of another content from another source.
